(19) United States
(12) Patent Application Publication
(10) Pub. No.: US 2025/0117003 A1
(43) Pub. Date: Apr. 10, 2025

(54) INTELLIGENT MANUFACTURING SYSTEM FOR PROCESS AND COMPONENT SAFETY

(71) Applicant: Rockwell Automation Technologies, Inc., Mayfield Heights, OH (US)

(72) Inventors: Devin Burke, Indianapolis, IN (US); Brian Martensen, Benton Harbor, MI (US); Liudmila Domakhina, Toronto (CA); Todd W. Jonckheere, Troy, MI (US); Michael W. Reinelt, Troy, MI (US); Anthony J. Murphy, Long Beach, CA (US)

(21) Appl. No.: 18/897,807

(22) Filed: Sep. 26, 2024

Related U.S. Application Data
(60) Provisional application No. 63/588,410, filed on Oct. 6, 2023.

(51) Int. Cl. G05B 23/02

(52) U.S. Cl. CPC G05B 23/0272; G05B 23/0235; G05B 2223/06

(57) ABSTRACT

Various systems and methods are presented regarding utilizing a centralized knowledge base to analyze various data inputs pertaining to current/future operation of a process, identify prior data pertaining to the current data inputs, identify potential issues, and further provide solutions/recommendations to address the potential issues, as well as responding to the data inputs. Data inputs can be an operator query, current process operation data, HACCP/FMEA data, work instructions, and suchlike. Data can be processed, e.g., vectorized, to enable similarity comparison between the input data and the historical data present in the knowledge base.

### CROSS-REFERENCE TO RELATED APPLICATIONS

This application claims priority to U.S. Provisional Patent Application No. 63/588,410 filed on Oct. 6, 2023 entitled “INTELLIGENT MANUFACTURING SYSTEM FOR PROCESS AND COMPONENT SAFETY”. The entireties of the aforementioned application are incorporated by reference herein.

### TECHNICAL FIELD

This application relates to automated systems and process for operation of an industrial process.

### BACKGROUND

Manufacturing/process data can be obtained from a variety of sources including, for example, data obtained from machines and processes involved in production of a component, such as manufacturing data generated from sensors, programmable logic controllers, machine settings/configurations, etc., operator activity and feedback, work flow instructions, component design data, quality control data, and suchlike. Further, while data can be provided and generated from within a company/organization, communication technologies enable data to be collected from external entities, e.g., other manufacturing companies associated and/or not associated with a first manufacturer, machine manufacturers/suppliers, material suppliers, customers, end users, research entities, regulatory entities (both public and private), and suchlike.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to automatically and dynamically identify an issue/recommendation regarding design safety and implementation of a component generated by a manufacturing process.

According to one or more embodiments, an intelligent manufacturing system (IMS) is presented, wherein the IMS comprises at least one processor, and at least one memory coupled to the at least one processor and having instructions stored thereon, wherein, in response to the at least one processor executing the instructions, the instructions facilitate performance of operations, comprising receiving first content, wherein the first content comprises first failure mode and effects analysis (FMEA) data relating to design of a component, and further identifying, in a collection of operating data, second content relating to the first content, wherein the collection of operating data comprises FMEA data obtained from one or more component designs, and the second content comprises second FMEA data, wherein the second content relates to the first content and the second FMEA data includes a failure mode, wherein the failure mode pertains to the component design. In a further embodiment, the operations can further comprise generating a notification comprising the failure mode and transmitting the notification to facilitate presentment of the failure mode relating to the design of the component.

In an embodiment, the first content can be received from a product design system utilized to design the component.

In another embodiment, the failure mode notification can be transmitted to a product design system, wherein the first content was compiled and generated by the product design system.

In another embodiment, the operations can further comprise representing the first content as a first vector, and further identifying the second content based on similarity between the first vector and a second vector representing the second content.

In a further embodiment, the first content is generated at a first product design system and the second content is generated at a second product design system, wherein the first product design system is located at a first location and the second product design system is located at a second location, wherein the first location and the second location are co-located, or the first location and the second location are remotely located.

In another embodiment, the IMS can be a multi-tenant system, and further, the IMS can be a cloud-based system.

In another embodiment, the first content can be generated at a first product design system and the second content can be generated at a second product design system, wherein the first product design system can be communicatively coupled to the IMS via a first application interface and the second product design system can be communicatively coupled to the IMS via a second application, wherein the first application interface can be located remote from the second application interface.

In another embodiment, the notification can further include a recommendation, wherein the recommendation provides information to address occurrence of the failure mode.

In another embodiment, the first content can be received in a query, and the second content is associated with a second query previously stored at the IMS, with the operations further comprising parsing the first query to identify a first semantic associated with the first query, and further identifying the second query based on similarity between the first semantic and a second semantic defined for the second query.

In further embodiments, a computer-implemented method is provided, wherein the method comprises receiving, by a device comprising at least one processor, first failure mode and effects analysis (FMEA) data relating to a component design and further comparing, by the device, the first FMEA data with a collection of FMEA data, wherein the collection of FMEA data is generated from prior quality and production risk analyses. In another embodiment, the operations can further comprise identifying, by the device, in the collection of FMEA data, second FMEA data, wherein the second FMEA data is threshold similar to the first FMEA data, further identifying, by the device, a failure mode associated with the second FMEA data, and further generating, by the device, a notification indicating the failure mode, wherein the failure mode is applicable to the component design.

In an embodiment, the device can be located in a multi-tenant system, and further the device can be located in a cloud-based system.

In another embodiment, the component design can be a first component design generated at a first product design system, and the second content can be a second component design generated at a second product design system, wherein the first product design system can be communicatively coupled to the device via a first application interface and the second product design system can be communicatively coupled to the device via a second application interface, wherein the first application interface and the second application interface are disparate.

In another embodiment, the notification can further include a recommendation, wherein the recommendation provides information associated with the second FMEA data to mitigate the failure mode.

In another embodiment, the first FMEA data comprises at least one of an attribute or a requirement relating to the component design, and the notification further includes a recommendation to achieve the at least one attribute or requirement.

In another embodiment, the collection of FMEA data comprises at least one of part information or design data.

In a further embodiment, the computer-implemented method can further comprise monitoring, by the device, a design process relating to the component design, further capturing, by the device, an event in the design process, wherein the first FMEA data correlates to the event, and further generating the first FMEA data from the event.

Further embodiments can include a computer program product stored on a non-transitory computer-readable medium and comprising machine-executable instructions, wherein in response to being executed, the machine-executable instructions cause an IMS to perform operations, comprising: (a) receiving first content, wherein the first content comprises failure mode and effects analysis (FMEA) data captured in response to an update being performed in a design process pertaining to a manufactured component, (b) identifying, in a collection of design data, second content, wherein the collection of design data comprises FMEA data obtained from one or more component designs and the second content comprises second FMEA data, wherein the second content relates to the first content, (c) identifying a failure mode associated with the second FMEA data, and (d) generating a notification comprising the failure mode.

In another embodiment, the IMS can be a multi-tenant system comprising a cloud-based system.

In a further embodiment, the design process can performed at a first product design system and the second content can be generated at a second product design system, wherein the first product design system can be located at a first location and the second product design system can be located at a second location, wherein the first location and the second location are co-located, or the first location and the second location are remotely located.

In a further embodiment, the first product design system can be communicatively coupled to the IMS via a first application interface and the second product design system can be communicatively coupled to the IMS via a second application, wherein the first application interface is located remote from the second application interface.

### DESCRIPTION OF THE DRAWINGS

One or more embodiments are described below in the Detailed Description section with reference to the following drawings.

FIG. 1 illustrates a system to assist resolution of an issue by utilizing information obtained from a multi-tenant system, in accordance with one or more embodiments.

FIG. 2 presents a plot illustrating clustering of respective vectors generated by vectorizing a query and operational data/prior queries, in accordance with an embodiment.

FIG. 3 presents a computer-implemented methodology for identifying a solution to a query, in accordance with an embodiment.

FIG. 4 presents a computer-implemented methodology for reviewing and amending a work instruction, in accordance with an embodiment.

FIG. 5 illustrates a schematic illustrating systems and components that can be utilized to assist with product review/design operations such as FMEA/HACCP, in accordance with one or more embodiments.

FIG. 6 presents a computer-implemented methodology for automatically designing a component/part/device while being in accordance/cognizant of respective safety issues/requirements pertaining to design and implementation of the part, in accordance with an embodiment.

FIG. 7 presents systems and components that can be utilized to assist with controlling operation of a process based on operational data captured regarding the process, in accordance with one or more embodiments.

FIG. 8 presents a computer-implemented methodology for automatically predicting/addressing a quality control issue pertaining to a manufacturing process, in accordance with an embodiment.

FIG. 9 presents a computer-implemented methodology for generating query responses based on combining information/data in a knowledge base, in accordance with an embodiment.

FIG. 10 presents a schematic of a system illustrating a configuration of a cloud-based IMS with multiple entities communicatively coupled thereto, in accordance with an embodiment.

FIG. 11 presents a flowchart of an example computer-implemented method for automatically and dynamically identifying prior process control data pertaining to current operation of the manufacturing process to enable identification of a quality control issue pertaining to the current operation, in accordance with an embodiment.

FIG. 12 presents a flowchart of an example computer-implemented method for automatically and dynamically identifying prior process control data pertaining to current operation of the manufacturing process to enable identification of a quality control issue pertaining to the current operation, in accordance with an embodiment.

FIG. 13 presents a flowchart of an example computer-implemented method for automatically and dynamically identifying prior process control data pertaining to current operation of the manufacturing process to enable identification of a quality control issue pertaining to the current operation, in accordance with an embodiment.

FIG. 14 presents a flowchart of an example computer-implemented method for automatically and dynamically identifying information pertaining to content in a query, in accordance with an embodiment.

FIG. 15 presents a flowchart of an example computer-implemented method for automatically and dynamically determining process information having the potential to address an issue presented in a query, in accordance with an embodiment.

FIG. 16 presents a flowchart of an example computer-implemented method for automatically and dynamically identifying information pertaining to a query regarding a manufacturing process, in accordance with an embodiment.

FIG. 17 presents a flowchart of an example computer-implemented method for automatically and dynamically identifying a potential failure mode relating to FMEA data identified during design of a component, in accordance with an embodiment.

FIG. 18, presents a flowchart of an example computer-implemented method for automatically and dynamically identifying a potential failure mode relating to FMEA data identified during design of a component, in accordance with an embodiment.

FIG. 19 presents a flowchart of an example computer-implemented method for automatically and dynamically identifying information pertaining to a query regarding a manufacturing process, in accordance with an embodiment.

FIG. 20 is a block diagram illustrating an example computing environment in which the various embodiments described herein can be implemented.

FIG. 21 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As used herein, “data” can comprise metadata. Further, ranges A-n and 1-i are utilized herein to indicate a respective plurality of devices, components, statements, attributes, etc., where n and i are any positive integer. The terms characterize, categorize, identify, determine, are used interchangeably herein.

Per the various embodiments presented herein, a variety of cloud-based, multi-tenant engineering platforms are presented, wherein, such platforms enable centralized pooling of manufacturing/process data from disparate sources further enabling the data to be available to entities associated with, subscribing to, the multi-tenant platform. A centralized knowledge base/platform is also referred to herein as an intelligent manufacturing system (IMS). Such centralized platforms having vast volumes of data from all levels of a manufacturing process enable/enhance operations and processes associated with any of: engineering resource planning (ERP), manufacturing execution systems (MES), quality management systems (QES), supply chain planning (SCP), production monitoring, MES automation and orchestration (A&O), asset performance management (APM), and the like. The various embodiments presented herein, regarding utilizing a centralized, multi-tenant platform/knowledge base, provide a wide range of benefits, such as, in a non-limiting list:
i) a machine operator can query the centralized data for assistance with a current issue at a machine/process, wherein the centralized data includes a solution implemented for a previous issue, wherein the previous issue pertains (e.g., is similar to) to the current issue,
ii) work instructions can be automatically reviewed to ensure they are meaningful/accurate for implementation at a process, e.g., with regard to content of a particular instruction, respective instructions do not give rise to conflicting conditions at a process/component being manufactured, and suchlike,
iii) degree of operator training/knowledge can be identified and supplemented, e.g., with knowledge captured from another operator, training packages, and suchlike,
iv) process operating conditions can be monitored and reviewed, enabling determination of whether current/drifting operating conditions may give rise to one or more quality control issues, e.g., statistical process control (SPC) data is generated from the current operating conditions, compared to historical SPC data, any quality control issues associated therewith can be identified, and operation of the current process can be adjusted to mitigate potential product quality issues,
v) knowledge pertaining to a current process condition and the response/solution thereto can be applied to the centralized system to further supplement the knowledge base for analysis/review of a subsequent issue, etc.,
vi) respective failure analysis concerns can be identified/reviewed during design of a component, design of a process to manufacture the component, etc. Such reviews can include hazard analysis and critical control point (HACCP) analysis, Failure Mode and Effects Analysis (FMEA), and suchlike. As the design process proceeds, respective attributes, design goals, etc., pertaining to the component/process can be provided/obtained by the IMS, automatically compared with prior HACCP/FMEA data in the knowledge base, and based thereon, the IMS can automatically provide feedback regarding whether a HACCP/FMEA issue potentially exists and how it can be addressed/avoided. Hence, the IMS can assist a design team/engineering team to address/meet HACCP/FMEA issues as they arise during product design/implementation.

In an embodiment, information provided to the IMS can be formatted as required for analysis and further processed to enable identification of information in the knowledge base pertaining to the provided information. In an embodiment, the provided information (e.g., operator query, SPC data, work instructions, operating condition data, FMEA/HACCP data, and suchlike) can be vectorized to enable similarity analysis with the information included in the knowledge base, whereby the information included in the knowledge base can be similarly vectorized. Hence, while an operator query input may be in text form/textual representation, for similarity analysis to be performed, the query input can be processed with a mathematical representation for which a vector value can be obtained and compared with vector values of the information in the knowledge base. Similarity analysis can be performed on the respective vectors, enabling existing operational data/prior actions, etc., to be identified, from which recommendations, responses, etc., can be generated and provided to the requesting entity (e.g., machine operator, process monitoring system, quality control system, and suchlike).

In an embodiment, current information/data (e.g., operator query, operating conditions, work instruction content and implementation, and suchlike) can be automatically compared with data in the knowledge base, data in the knowledge base pertaining/similar to the current information/data can be automatically identified, with one or more recommendations/improvements being automatically provided to an operator/engineering team/concerned entity.

### General Operation of IMS and Implementation to Assist Operation of a Machine/Component Fabrication

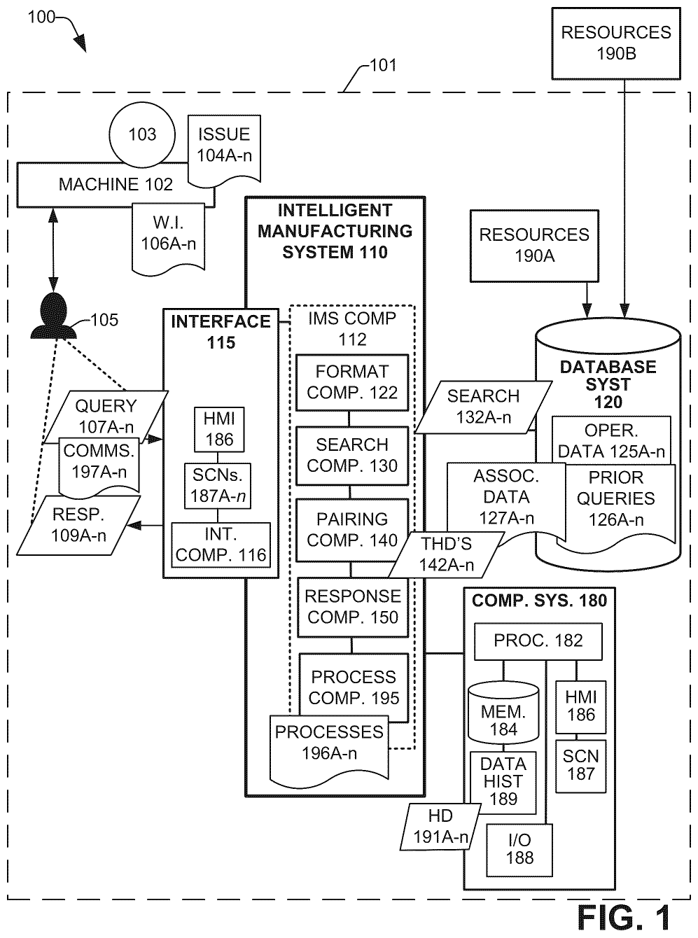

Turning to FIG. 1, system 100 illustrates a system to assist resolution of an issue by utilizing information provided by/available at a multi-tenant system, in accordance with an embodiment. System 100 presents a machine 102 being operated/monitored by operator 105, e.g., operator 105 is a front-line worker/employee controlling fabrication of a part 103 on machine 102. In an example scenario, machine operator 105 encounters an issue 104A-n while performing/completing a task (e.g., as identified in a work instruction 106A-n) in accordance with manufacture of the part 103.

Ideally, operator 105 has sufficient knowledge/experience to address an issue 104A-n. However, a scenario can occur whereby operator 105 is not experienced with manufacturing the part 103, operator 105 has not previously encountered the issue 104, and suchlike. Accordingly, the operator 105 may seek further assistance to address the issue 104.

System 100 further comprises an intelligent manufacturing system (IMS) 110, whereby IMS 110 can be configured to assist operator 105 in addressing the issue 104. In an embodiment, machine 102, IMS 110 (and associated database 120) can be co-located, e.g., both machine 102 and IMS 110 are owned and operated by the same entity, company, etc., as indicated by outline/box 101. In an alternative embodiment, IMS 110 can be remotely located from the machine 102, whereby interaction between the operator 105 and the IMS 110 is via a local interface 115, e.g., IMS 110 is a cloud-based computing system. In another embodiment, IMS 110 is located local at company 101, while the database system 120 (e.g., operating as a knowledge base) is remotely located from IMS 110/company 101.

In an embodiment, IMS 110 can be communicatively coupled to/includes the database system 120 comprising operational data 125A-n. Database system 120 can further include one or more prior queries 126A-n comprising previous interactions between operator 105 (and other entities, not shown) and IMS 110 and the operational data 125A-n. E.g., prior query 126A is a query performed by another operator 105B of machine 102 regarding manufacture of the part 103 on machine 102. Database system 120 can be an intelligent system configured to analyze any data/information located at the database system 120, e.g., operational data 125A-n, queries 126A-n.

Operational data 125A-n and prior queries 126A-n can be sourced from systems and machines (resources 190A) operating at the company 101. Operational data 125A-n and prior queries 126A-n can also be sourced from systems and machines (resources 190B) external to company 101, whereby database system 120 is a multi-tenant system. Operational data 125A-n and prior queries 126A-n can pertain to one or more components 103A-n/designs of components 103A-n, such that an input (e.g., a query 107A-n, and similarly FMEA/design data 507A-n, SPC data 707A-n, as further described) can be directed to a first component 103 (a.k.a. a component 103A) of interest at a manufacturing center, and the like, while operational data 125A-n and prior queries 126A-n can relate to the first component 103A or a second component 103B being similar/substantially similar/threshold similar to the first component 103A. Similarly, as further described, first FMEA/design data 507A generated by product design system 502 can be similar/substantially similar/threshold similar to FMEA/design data 530A-n included in operational data 125A-n and prior queries 126A-n. Further, as further described, first SPC data 507A (pertaining to component 103/103A) generated by monitoring system 710 can be similar/substantially similar/threshold similar to SPC data 730A-n included in operational data 125A-n and prior queries 126A-n.

Operational data 125A-n and prior queries 126A-n can also have data associated therewith, referred to herein as associated data 127A-n (and also solutions 127A-n). Associated data 127A-n can include information/data regarding one or more activities performed/potential solutions determined as a function of previous interaction(s) with operational data 125A-n and prior queries 126A-n. For example, when a prior query 126N was submitted to the IMS 110, and one or more of operational data 125A-n or prior queries 126A-n were identified and paired with the prior query 126N, the recommended solution/action/response 127N determined from the one or more of operational data 125A-n or prior queries 126A-n can be identified and further utilized to generate a response 109N presented to operator 105, the recommended action/solution 127N can be stored in database system 120 and assigned/associated with/mapped to, for example, operational data 125N and/or prior query 126N.

As previously mentioned, in an embodiment, IMS 110 can be a cloud-based computing system, configured to enable interaction with respective entities (e.g., manufacturing sites potentially located anywhere around the globe, the manufacturing global community) constituting resources 190A and 190B. Hence, operational data 125A-n and prior queries 126A-n can comprise of a vast corpus of knowledge regarding the plethora of issues encountered during manufacture of anything from a washer/spacer through to manufacture of spacecraft, and anything in between. IMS 110 and database system 120 can function as a central repository of operational information (e.g., operational data 125A-n and prior queries 126A-n) from potentially every entity across the globe involved in manufacturing.

It is to be appreciated that while the various embodiments presented herein relate to manufacture/manufacturing, the various embodiments are not so limited and can be applied to any suitable application pertaining to analysis of a knowledge base generated by a plurality of resources, e.g., IMS 110 and database system 120, whereby data regarding medical issues, finance, construction, transportation, mining, etc., all can utilize a system based on IMS 110 and database system 120.

As shown, IMS 110 can include an interface 115 (e.g., a front-end system) via which operator 105 can interact with IMS 110. In an embodiment, interface 115 can be a chat-interface, a chatbot, an application programming interface (API), and suchlike, configured to enable operator 105 to interact with IMS 110. In an example embodiment, operator 105 can generate and provide a query 107A-n to IMS 110. In an example scenario, operator 105 is stepping through a series of work instructions 106A-n regarding manufacture of part 103 and inputs a query 107 via interface 115 detailing an issue 104A-n “I cannot install the 5 cm bolt”. Interface 115 can be configured to receive and submit the query 107 to the IMS 110.

As shown in FIG. 1, IMS 110 can include various computer-executable components/sub-components such as an IMS component 112, format component 122, a search component 130, a pairing component 140, a response component 150, and a process component 195. The terms IMS 110 and IMS component 112 are used interchangeably herein.

IMS component 112 can be configured to receive a query 107A-n (e.g., comprising first content), determine an activity/action (e.g., per associated data 127A-n) for the query based on operational data 125A-/prior queries 126A-n (e.g., comprising second content) determined to relate (e.g., having similarity) to the query 107A-n, and further present the activity as a response 109A-n to operator 105. IMS component 112 can include various components/sub-components, as further described.

Format component 122 can be configured to format content of query 107A-n to a format applicable for analysis by IMS 110. In an embodiment, content of query 107A-n can be in textual form/textual representation, e.g., a text entry, an utterance, and suchlike. Format component 122 can be configured to convert the textual representation of query 107A (e.g., a first format query 107A-1) into a mathematical representation (e.g., a second format query 107A-2), e.g., a vectorized version of query 107A. Similarly, the operational data 125A-n and prior queries 126A-n can be stored in any suitable format, whereby the format enables the IMS 110, or respective sub-component, to query the operational data 125A-n and prior queries 126A-n based on content of query 107A. Accordingly, operational data 125A-n and prior queries 126A-n can be stored in database 120 with the same format (e.g., a second format) as applied to query 107A to form second format query 107A-2.

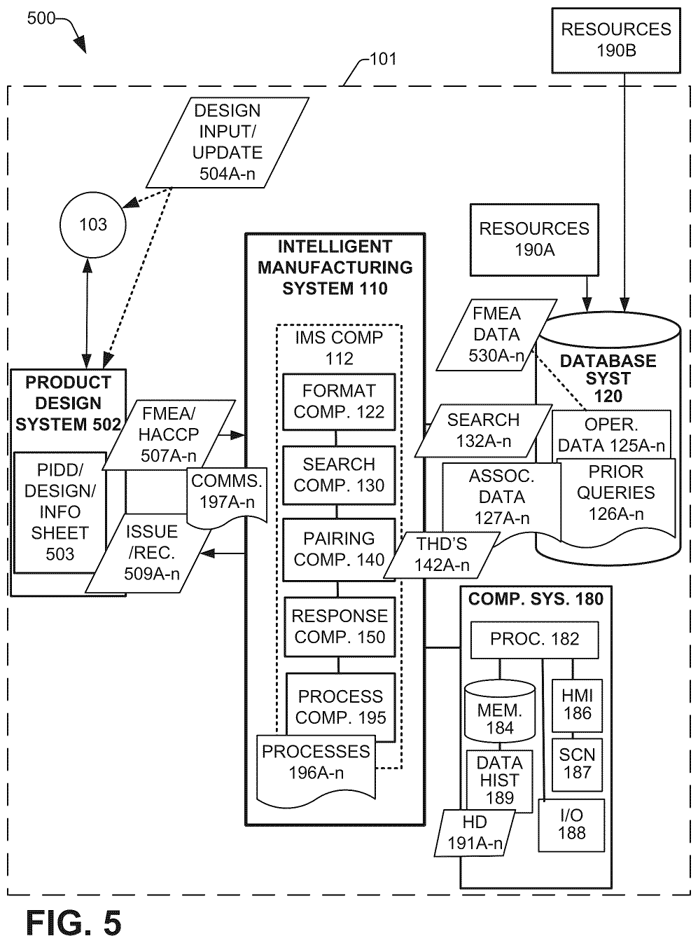

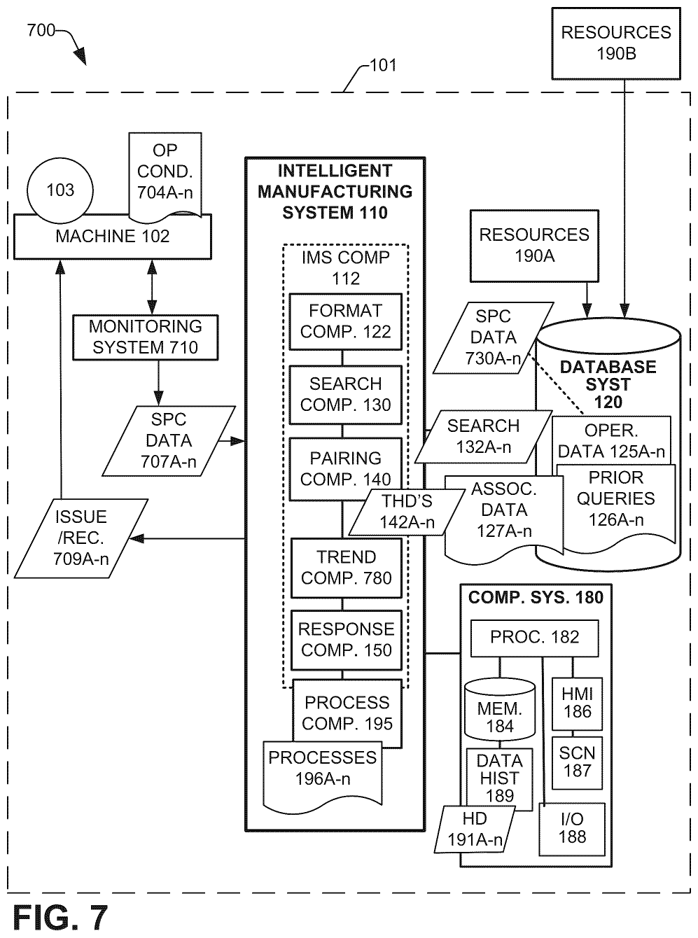

Search component 130 can be configured to query content of operational data 125A-n and prior queries 126A-n based on content of query 107A-2. Search component 130 can be configured to generate various searches 132A-n, whereby each search 132A-n can be based on the content of second format query 107A-2. Given the textual nature of query 107A-n, and further, how different operators/entities generate a query concerning the same issue 104A-n, e.g., language, dialect, shop floor speak, engineering speak, etc., search component 130 can be configured to generate a series of searches 132A-n based on the inherent vagaries of query 107A-2. Further, where information is being provided from a computer-based system (e.g., product design system 502 of FIG. 5, process monitoring system 710 of FIG. 7) format component 122 and search component 130 can be configured to function in accordance with the respective computer language/program utilized at the computer-based system. In an embodiment, the computer-based system can be configured to provide the query 107A-n (and FMEA/HACCP information 507A-n, SPC data 707A-n in a format suitable for vectorization).

Pairing component 140 can be configured to identify any operational data 125A-n and/or process queries 126A-n pertaining to the one or more searches 132A-n. Any suitable analysis can be performed, for example similarity analysis of any of the vectored query 107B-2, vectored prior query 126A-2, vectored operational data 125A-2, and suchlike. It is to be appreciated that while the original query 107A-n (e.g., in textual form) and the solution 127A-n (e.g., in textual form) are represented as being converted to respective vectored content, e.g., vectored query V105 and vectored solution V125A, V125B, etc., any suitable format can be utilized to enable a text entry (e.g., first format, original format) to be submitted into the IMS 110, conversion to a mathematical representation (e.g., second format) to enable analysis/comparison with existing data 125A-n/126A-n, identification of applicable information in data 125A-n/126A-n, and selection/presentment of the applicable information/solution 127A-n as a response 109A-n to query 107A-n. Continuing the example scenario, the pairing component 140 determines that a prior response/solution 127A-n “try applying temporary adhesive to align bolt at the vertical angle and then insert” in prior query 126C pertains to (e.g., has similar vectored content) the vectored representation 107A-2 of original query 107A-1 “I cannot install the 5 cm bolt”.

Response component 150 can be configured to generate a response 109A-n based on the analysis and results provided by pairing component 140, e.g., response 109A includes the content/instruction 127A-n “try applying temporary adhesive to align bolt at the vertical angle and then insert” in prior query 126C. Response 109A can be presented to operator 105 via HMI 186/screens 187A-n. Accordingly, operator 105 can implement, at machine 102, the actions/instructions/solution 127A-n provided in the response 109A. Hence, per the foregoing, the entry of a query 107A into, and a response 109A from, the IMS 110 is comparable to IMS 110 functioning as an experienced operator assisting operator 105.

As further shown, IMS 110 can be communicatively coupled to/include a computer system 180. Computer system 180 can include a memory 184 that stores the respective computer executable components (e.g., IMS component 112, interface component 115, format component 122, search component 130, pairing component 140, response component 150, process component 195, and suchlike) and further, a processor 182 configured to execute the computer executable components stored in the memory 184. Memory 184 can further be configured to include the database system 120, and thus store any of issues 104A-n, work instructions 106A-n, queries 107A-n, responses 109A-n, operational data 125A-n, prior queries 126A-n, similarity indexes S₁₋ₙ, vectors Vx, and suchlike (as further described herein). The computer system 180 can further include a human machine interface (HMI) 186 (e.g., a display, a graphical-user interface (GUI)) which can be configured to present various information including the queries 107A-n, responses 109A-n, operational data 125A-n, prior queries 126A-n, and suchlike, (as further described) per the various embodiments presented herein. HMI 186 can include an interactive display/screen 187A-n to present the various information. Computer system 180 can further include an I/O component 188 to receive and/or transmit (e.g., in communications 197A-n) respective query 107A-n, responses 109A-n, operational data 125A-n and prior queries 126A-n from resources 190A and 190B, and suchlike (and data/information pertaining to FMEA operations and SPC analysis, per FIGS. 5 and 7). Computer system 180 can further include a data historian 189 configured to compile as historical data 191A-n, any of operational data 125A-n, prior queries 126A-n, associated data 127A-n, thresholds 142A-n, searches 132A-n, received queries 107A-n, issues 104A-n, responses 109A-n, PIDD/design information 503A-n, FMEA/design data 507A-n, issues/recommendations 509A-n, operating conditions 704A-n, SPC data 707A-n, issues/recommendations 709A-n, communications 197A-n, regarding manufacture of a collection of parts 103A-n, prior FMEA/design data 530A-n, prior SPC data 730A-n, and the like, as further described, wherein the data historian 189 can be configured to store the historical data 191A-n in database 120 (e.g., at memory 184 or as a standalone system). Accordingly, the historical data 191A-n is available to any entity communicatively coupled to IMS 110.

With IMS 110 communicatively coupled to machine 102, e.g., via application interface 115 (as well as product design system 502, monitoring system 710, as further described), multiple communications 197A-n can be generated/transmitted by any of the systems/devices/components included in system 100 (and systems 500 and 700), wherein the communications 197A-n can comprise notifications (e.g., response 109A-n, notification of an issue 509A-n, notification of an issue 709A-n), recommendations (e.g., in response 109A-n, recommendation to address issue 509A-n, recommendation to address issue 709A-n, and the like), queries (e.g., queries 107A-n), transmission of data (e.g., design/FMEA data 507A-n, SPC data 707A-n), and the like.

IMS 110 can further include a process component 195 and processes 196A-n. It is to be appreciated that processes 196A-n can comprise any artificial intelligence/machine language (AI/ML) model/technology/technique/architecture utilized to identify operational data 125A-n/prior queries 126A-n having content similar to the content of the query 107A-n. The process component 195 can be utilized to implement processes 196A-n in conjunction with any of the other components included in IMS 110, e.g., IMS component 112, format component 122, search component 130, pairing component 140, response component 150, interface component 116, and suchlike.

It is to be appreciated that the various processes 196A-n and operations presented herein are simply examples of respective AI and ML operations and techniques, and any suitable technology can be utilized in accordance with the various embodiments presented herein. Processes 196A-n can be based on application of terms, codes, statements, etc., in queries 107A-n (and operational data 125A-n/prior queries 126A-n), whereby processes 196A-n can include a vectoring technique such as bag of words (BOW) text vectors, and further, any suitable vectoring technology can be utilized, e.g., Euclidean distance, cosine similarity, etc. Other suitable AI/ML technologies that can be applied include, in a non-limiting list, any of vector representation via term frequency-inverse document frequency (tf-idf) capturing term/token frequency in the queries 107A-n versus operational data 125A-n/prior queries 126A-n, neural network embedding layer vector representation of terms/categories (e.g., common terms having different tense), bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BILSTM, and suchlike. Accordingly, in an embodiment, implementation of the IMS component 112, format component 122, search component 130, pairing component 140, response component 150, and suchlike, enables NLP (e.g., utilizing vectors) to be implemented on the queries 107A-n.

Language models, LSTMs, BARTs, etc., can be formed with a neural network that is highly complex, for example, comprising billions of weighted parameters. Training of the language models, etc., can be conducted, e.g., by process component 195, with datasets, whereby the datasets can be formed using any suitable technology, such as operational data 125A-n, prior queries 126A-n, and suchlike. As previously mentioned, the operational data 125A-n/prior queries 126A-n can be received from resources 190A, resources 190B, operator 105, and suchlike. Further, as previously mentioned, queries 107A-n, operational data 125A-n, prior queries 126A-n, and suchlike, can comprise text, alphanumerics, numbers, single words, phrases, short statements, long statements, expressions, syntax, source code statements, machine code, etc. Fine-tuning of a LM can comprise application of operational data 125A-n/prior queries 126A-n to the LM, the LM is correspondingly adjusted by application of the operational data 125A-n/prior queries 126A-n, such that, for example, weightings in the LM are adjusted by application of the operational data 125A-n/prior queries 126A-n.

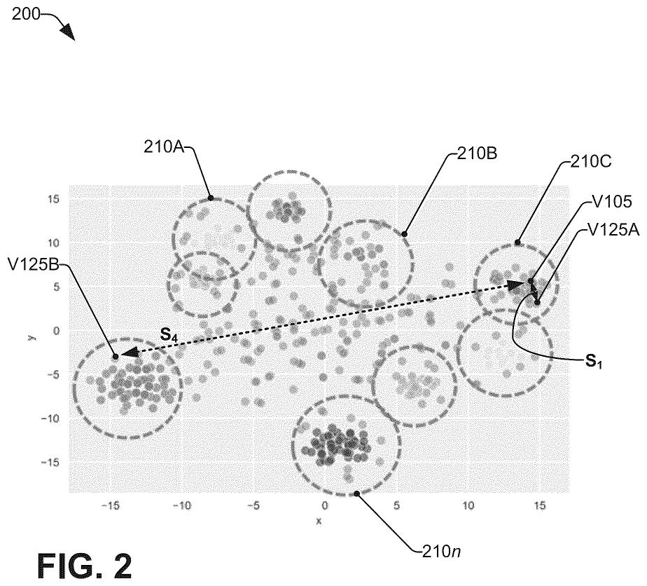

Content in both the queries 107A-n and the operational data 125A-n/prior queries 126A-n having a similar vector representation can form clusters when represented on a similarity plot. FIG. 2, plot 200 illustrates clustering of respective vectors generated by vectorizing a query and operational data/prior queries, in accordance with an embodiment. Plot 200 represents a two-dimensional plot of various vectors Vx and potential cluster formation, whereby vectors V125A-n are mathematical representations of the operational data 125A-n/prior queries 126A-n, and vector V105 is a mathematical representation of a query 107A. As shown in FIG. 2, the distance, e.g., similarity distance Sn, between respective vector values Vx indicates the degree of similarity between the query 107A and operational data 125A-n/prior queries 126A-n derived from the vectors V105 and V125A. Per the example schematic presented in FIG. 2, a similarity distance S₁ can be determined (e.g., by pairing component 140) between the value of vector V105 and vector V125A, and further, a similarity distance S₄ can be determined between the value of vector V105 and vector V125B. Hence, given that similarity distance S₁ is less than similarity distance S₄, an inference can be made (e.g., by pairing component 140) that the content of query 107A has a high degree of similarity with the content of prior query 126A, while the content of query 107A has a low degree of similarity with the content of prior query 126B. As previously mentioned, the degree of similarity between query 107A and a prior query 126B can be determined based on a threshold 142A-n reflecting a proximity of a first vector generated from query 107A and a second vector generated from a prior query 126A. As shown in FIG. 1, pairing component 140 can be configured to determine a degree of similarity S (e.g., a similarity index S₁₋ₙ) between the content of query 107A-n and operational data 125A-n/prior queries 126A-n mapped to associated data 127A-n. In an example implementation, per FIG. 2, a similarity S₁₋ₙ can be assessed based on similarity/dissimilarity as identified based on distance between respective values of vectors Vx. Pairing component 140 can be configured to function with one or more thresholds 142A-n. For example, a threshold 142A has to be exceeded for an acceptable degree of similarity S to be inferred between query 107A-n and operational data 125A-n/prior queries 126A-n. In an embodiment, thresholds 142A-n can be established as a function of distance between two vectors, such that a distance S₁ indicates 95% similarity, a distance S₂ indicates 85% similarity, a distance S₃ indicates 75% similarity, a distance of S₄ or less indicates a similarity of less than 75% (with the pairing component 140 inferring that no similarity exists), and suchlike. It is to be appreciated that any suitable determination of similarity S can be utilized for the various embodiments presented herein.

Pairing component 140 can be configured to determine similarity based on text, semantics, textual summarization, etc., between various items of interest (e.g., pairings of query 107A-n and respective operational data 125A-n/prior queries 126A-n). To enable subsequent review of the query 107A-n and operational data 125A-n/prior queries 126A-n, clusters of vectors can be analyzed. Any suitable clustering technique can be utilized by the pairing component 140, e.g., vector quantization (VQ). In an embodiment, pairing component 140 can cluster the vectors V125A-n and V105 based on their respective vector representation. For example, a k-means clustering algorithm, such as a radius-based k-means clustering algorithm, can be applied by the pairing component 140 to cluster the vectors V125A-n and V105 into clusters comprising vectors that have the same, similar, or approximate value. Hence vectors in cluster 210A represent queries/data (e.g., queries 107A-n and respective operational data 125A-n/prior queries 126A-n) having similar functionality/content, and similarly clusters 210B, 210C, and 210n comprise queries/data having respectively similar functionality/content.

Interaction between the operator 105 and IMS 110 can proceed whereby the operator 105 can perform the action 127A-n as instructed and further provide feedback, e.g., via a subsequent query 107A-n, indicating whether the recommended action 127A-n was successful or not. In the event of the recommended action 127A-n was a success, the database system 120 can be updated with an entry mapping the query 107A-n with the recommended action 127A-n, and further to operational data 125A-n/prior queries 126A-n mapped to solution 127A-n, and that the recommended action 127A-n was successfully implemented. Accordingly, the prior data 125A-n/126A-n has become current as a function of the data being updated to indicate successful use of solution 127A-n at the present time, and hence, the prior data 125A-n/126A-n is still relevant to the manufacturing of part 103. In the event of the recommended action 127A-n was not successful, further review by the IMS component 112 can be performed whereby response 109A-n can be presented (e.g., via HMI 186) and includes a question/request for further information from operator 105, enabling IMS component 112 to obtain further information regarding the issue 104A-n to facilitate further review of the data 125A-n/126A-n. In the event of issue 104A-n cannot be resolved by IMS component 112, issue 104A-n can be escalated, e.g., IMS 110 can be configured to notify (e.g., via a response 109A-n) a manufacturing supervisor of the issue 104A-n, enabling the supervisor to assist operator 105 in a timely manner, etc.

In an embodiment, the IMS 110 can be further configured to review a work instruction 106A-n generated in accordance with manufacturing part 103, in conjunction with interaction by operator 105 with IMS 110 (e.g., per queries 107A-n and responses 109A-n). In an embodiment, IMS 110 can review the work instruction 106A-n to determine whether the work instruction 106A-n should be amended. For example, based on queries 107A-n submitted by operator 105 and responses 109A-n, IMS 110 can automatically identify that a prior step (e.g., process step 5) in the work instruction 106A-n is giving rise to the current issue 104A-n, whereby the current issue 104A-n is occurring at process step 11 of work instruction 106A-n, for example. Based on information in data 125A-n/126A-n, IMS 110 can determine that there is a conflict between the action performed at process step 5 and the current issue at process step 11. IMS 110 can identify/present one or more solutions 127A-n to the issue 104A-n, including, for example, “adjustment of process step 5 of work instruction is recommended, recommend subsequently positioning component at position X to enable access with bolt aligned at angle X”. In an embodiment, the recommendation 127A-n in response 109A-n can be reviewed (e.g., by operator 105, manufacturing supervisor, engineering, etc.) to confirm that the recommendation 127A-n can be utilized. In another embodiment, IMS 110 can be configured to automatically update the work instruction 106A-n with the proposed solution 127A-n included in response 109A-n. Hence, with the work instruction 106A-n being a sequence of commands for machine 102 (e.g., a CNC machine), the command at process step 5 of the work instruction 106A-n can be automatically adjusted by the IMS 110 (e.g., by implementing solution 127A-n) to address issue 104A-n arising at process step 11.

In another embodiment, the queries 107A-n and responses 109A-n can be reviewed to determine whether the work instruction 106A-n itself is giving rise to issues 104A-n. For example, upon review of work instruction 106A-n, IMS 110 may identify that many queries 107A-n are being generated as an operator 105 works through the work instruction 106A-n. IMS 110 identifies that responses 109A-n to queries 107A-n pertain to a particular aspect of the work instruction 106A-n, whereby the particular aspect (e.g., a step) can be isolated/extracted from the work instruction 106A-n, a similar step can be identified in the operational data 125A-n and prior queries 126A-n, however, the identified similar step may be easier to understand than the step currently in the work instruction 106A-n. Based thereon, IMS 110 can generate a response 109A-n indicating the issue 104A-n pertaining to the queries 107A-n relates to an instruction in the work instruction 106A-n and that wording of the work instruction 106A-n can be improved to reduce/address the issue 104A-n and the queries based thereon.

With regard to identification/generation of a solution 127A-n, pairing component 140 can be configured to generate a solution 127A-n from information in two or more operational data 125A-n and prior queries 126A-n. IMS 110 can be configured with AI and ML (e.g., in processes 196A-n) to determine that while a first operational data 125A does not effectively respond to a query 107A, and a second operational data 125B does not effectively respond to the query 107A, operational data 125A and operational data 125B are sufficiently similar to the content of the query 107A, that a solution 127A generated from a combination of the respective content of operational data 125A and operational data 125B has a greater similarity to the query 107A. Hence, implementation of AI and ML technology enables IMS 110 to generate solutions 127A-n and responses 109A-n that intelligently combine knowledge present in the operational data 125A-n and prior queries 126A-n.

An issue faced by companies is both employee retention, and further, retention of employee knowledge. For example, an employee with 20 years experience is to retire, with 20 years of experience being a substantial amount of knowledge that is leaving the manufacturing facility. By utilizing the IMS 110 to monitor and capture operations (e.g., adjustments) performed by the retired operator during prior manufacture of part 103, the experience of the retired operator can be captured digitally in operational data 125A-n. Hence, when a new operator, operator 105, takes over operation of the machine 102, by enabling interaction with the captured operational data 125A-n, operator 105 is effectively drawing on the experience of the retired employee, and in effect, the retired employee is still available/present, albeit digitally, to assist operator 105 manufacture part 103. Further, by providing an interface 115 configured to receive a query 107A in a text form, operator 105 can easily submit a request for assistance and further receive a timely response 109A, thereby enabling manufacture of part 103 to proceed expeditiously, but further reduce potential frustration experienced by the operator 105 as they familiarize themselves with production of part 103/operation of machine 102.

In another embodiment, the query/response interaction by operator 105 with IMS 110 can, in itself, also be reviewed, and recommendations generated based thereon. For example, the one or more queries 107A-n generated by operator 105 and the implementation of the responses/recommendations 109A-n, the success of the implementations on machine 102, etc., can be reviewed to determine whether operator 105 is lacking a particular skillset. Accordingly, IMS 110 can review training provided to the operator 105, and, for example, (a) determine whether the operator has completed prior training (per their human resources (HR) file) that relates to the issue(s) 104A-n being experienced at the machine 102, (b) identify when the next training is scheduled for the operator 105, and whether it should be brought forward, (c) identify further training that is not currently scheduled for the operator 105 but would be of benefit, (d) identify training that is not currently provided at the manufacturing facility to the operator 105 and/or any of the employees, and suchlike. Regarding (d), advantage can be taken of operational data 125A-n is sourced from multiple resources 190 (e.g., IMS 110 is a multi-tenant system), both internal to the manufacturing facility/enterprise, as well as from external entities. For example, IMS 110 identifies an issue in the training provided to operator 105 whereby operator 105 has not been trained to address an issue 104A-n regarding manufacture of part 103, a similar situation was experienced and identified at a manufacturing facility (e.g., resource 190B) that is not part of the operator 105's company 101 but provides operational information 125A-n to the database system 120. In addressing an issue at the remote manufacturing facility similar to issue 104A, the issue was successfully addressed at the other company by providing the operators with further training. The further training provided at the other company can be identified by IMS 110, and further, IMS 110 can identify that operator 105 has not partaken in such training (e.g., based on analysis of operator 105's human resources/training record by IMS 110), and accordingly, IMS 110 can provide a recommendation 109A-n that the further training provided at the remote manufacturing facility be provided to operator 105 and, if needed, other employees of company 101. Accordingly, implementation of IMS 110 not only assists the operator 105 in addressing a current issue 104A-n at a machine 102, (manufacturing station), but further reviews knowledge/experience of operator 105 to enable providing operator 105 with skills and training to enable the operator 105 to perform their job with as few frustrations/issues as possible. Hence, operator 105 is drawing from the experience of previous employees (e.g., the retired employee), one or more solutions generated from operational data 125A-n/prior queries 126A-n, and suchlike, thereby bringing operator 105 up to speed and further reduce their daily frustrations, thereby increasing the likelihood that operator 105 will desire to remain an employee of company 101 which further causes operator 105's knowledge and experience to remain at the manufacturing facility. As mentioned, any operational data 125A-n/prior queries 126A-n associated with the machining issue 104A-n, training of operator 105, and suchlike, can be maintained/updated in view of the interaction (queries 107A-n and responses 109A-n) and outcome of the interaction. Accordingly, implementation of IMS 110 aids in operator/plant productivity and quality, increasing employee/knowledge retention and advancement of skillsets, thereby enabling continuous improvement of the manufacturing operations and the employees involved with them.

In an embodiment, interface 115 can be configured to receive queries 107A-n in any applicable manner, e.g., text entry via a keyboard at HMI 186, speech entry via a microphone at HMI 186, drag and drop entry via a touch screen 187A-n, and suchlike. Accordingly, interface 115 can be configured to receive the queries 107A-n in whatever manner operator 105 prefers, and further, interface 115 can include an interface component 116 configured to adjust operation of interface 115 such that interface 115 is personalized/tailored to the needs of operator 105, such as language, dialect, phrases, etc. Accordingly, operator 105 can interact with IMS 110, via interface 115, in the same manner as if IMS 110 was a fellow employee. Hence, rather than operator 105 having to provide queries 107A-n in a particular format (e.g., specific engineering terms, sequence of terms, etc.), the interface component 116 can be configured to receive statements from the operator 105 and parse the statements to identify the issue 104A-n being raised by the operator 105.

It is to be appreciated that while the foregoing discloses IMS 110 interacting with operator 105 (e.g., queries 107A-n, responses 109A-n, and suchlike), the various embodiments presented herein also pertain to any associated staff/personnel at company 101 associated with operation of machine 102 and/or manufacture of part 103 (and associated issues 104A-n). For example, quality control engineers, engineering team, design team, maintenance team, human resources/training, etc., can also be informed of the issues 104A-n as they arise, queries 107A-n submit by operator 105 into IMS 110, SPC data 707A-n, FMEA/HACCP data 507A-n, operational data 125A-n/prior queries 126A-n identified in resolving the issue 104A-n, content/recommendations provided to operator 105 in the responses 109A-n, and suchlike.

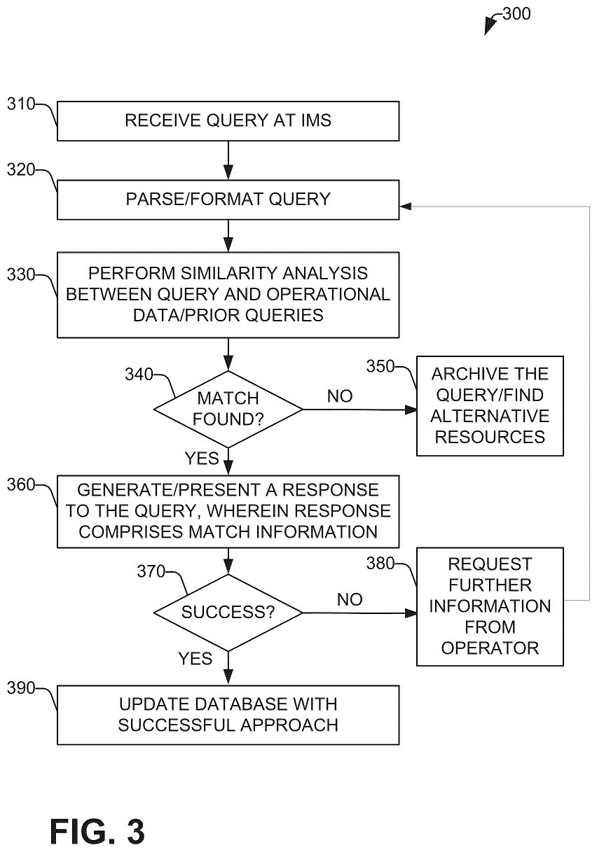

FIG. 3 presents a computer-implemented methodology 300 for identifying a solution to a query, in accordance with an embodiment.

At 310, a query 107A-n can be received at an IMS 110, wherein the query 107A-n relates to an issue 104A-n concerning operation of a machine 102 and/or a part 103 being manufactured at the machine 102, wherein oversight of machine 102 can be by operator 105. Operation of machine 102 and/or part 103 can be performed in conjunction with a work instruction 106A-n. In an embodiment, the query 107A-n can be submitted by an operator 105 of the machine.

At 320, the query 107A-n can be parsed by the IMS 110 to determine content of the query 107A-n and further formatted to facilitate similarity matching between the query 107A-n and operational data 125A-n/prior queries 126A-n.

At 330, similarity analysis can be performed by IMS 110 to identify one or more items of operational data 125A-n and/or prior queries 126A-n that pertain to the content of the query 107A-n.

At 340, in response to a determination by IMS 110 that NO operational data 125A-n/prior queries 126A-n matches the content of the query 107A-n, methodology 300 can advance to 350, whereupon the query 107A-n can be archived to facilitate future analysis of the query 107A-n (e.g., as further operational data 125A-n/prior queries 126A-n are received at the IMS 110, e.g., in database 120). Further, other resources can be sought out to address the issue, e.g., review by operator 105 and other operators to determine a novel solution, whereby the novel solution can be subsequently provided to the IMS 110 as operational data 125A-n.

At 340, in response to a determination by IMS 110 that YES operational data 125A-n/prior queries 126A-n exist matching the content of the query 107A-n, methodology 300 can advance to 360, whereupon the solution 127A-n to the query 107A-n can be provided to the operator 105 (e.g., via an interface 115). As previously mentioned, the solution to the query 107A-n can be included in the associated data 127A-n.

At 370, upon implementation of the solution provided in the response 109A-n, further review can be performed (e.g., by operator 105, a system monitoring machine 102, and suchlike) to determine whether the solution (e.g., identified in operational data 125A-n/prior queries 126A-n) was successful. At 370, in response a subsequent query 107A-n from operator 105 indicating that the solution was not successful, methodology 300 can advance to 380, whereupon further information can be requested by the IMS 110 regarding operation of machine 102. Methodology 300 can further return to act 320, whereupon the further information can be provided as a query 107A-n.

At 370, in response to a determination that YES, the solution in response 109A-n was successful in addressing the issue 104A-n, methodology 300 can advance to act 390, whereby the operational data 125A-n/prior queries 126A-n pertaining to the successful solution of issue 104A-n can be identified in database 120, in conjunction with the issue 104A-n resolved and further the content of query 107A-n. Accordingly, operational data 125A-n/prior queries 126A-n+resolved issue 104A-n+content of query 107A-n can be implemented in review of a subsequently received issue 104A-n. In further response to the successful solution, the solution included in the associated data 127A-n can be saved in database system 120, whereby the associated data 127A-n can be mapped to the operational data 125A-n/prior queries 126A-n that provided the solution.

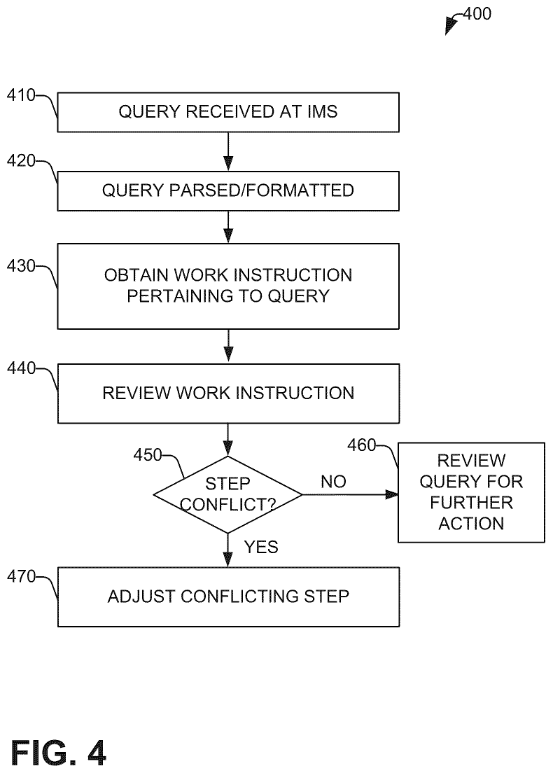

FIG. 4 presents a computer-implemented methodology 400 for reviewing and amending a work instruction, in accordance with an embodiment.

At 410, a query 107A-n can be received at an IMS 110, wherein the query 107A-n relates to an issue 104A-n concerning operation of a machine 102 and/or a part 103 being manufactured at the machine 102, wherein oversight of machine 102 can be by operator 105. Operation of machine 102 and/or part 103 can be performed in conjunction with a work instruction 106A-n. In an embodiment, the query 107A-n can be submitted by an operator 105 of the machine.

At 420, the query 107A-n can be parsed by the IMS 110 to determine content of the query 107A-n and further formatted to facilitate similarity matching between the query 107A-n and operational data 125A-n/prior queries 126A-n.

At 430, the IMS 110 can be configured to obtain the work instruction 106A-n.

At 440, the IMS 110 can be configured to review the work instruction 106A-n, wherein the work instruction 106A-n can comprise a series of steps. The steps relate to respective functions/operations/activities to be performed at the machine 102/by operator 105. A determination can be made by IMS 110 regarding whether an activity/function performed at a first step conflicts with an activity/function performed at a second step in the work instruction 106A-n.

At 450, in response to NO, the issue arising in query 107A-n does not relate to a step conflict and/or there is no step conflict present, methodology 400 can advance to act 460 whereby the query 107A-n can be further reviewed to determine if a solution/recommendation can be identified, and if so, operator 105 can be notified about the recommendation in a response 109A-n.

At 450, in response to YES, the issue arising in query 107A-n pertains to a conflict in operations (steps) performed in work instruction 106A-n, methodology 400 can advance to act 470, whereby the respective conflicting steps can be reviewed by IMS 110, and the work instruction 106A-n modified to prevent the conflict.

### Analysis of FMEA/HACCP Design Data

In a further embodiment, during design of a component/device/system, various analyses can be performed regarding the safety of the device, etc. Such reviews can include HACCP analysis, FMEA, and suchlike. With a conventional approach, FMEA and HACCP analysis can be labour intensive, costly, and time consuming/lengthy. Accordingly, the knowledge comprising the operational data 125A-n/prior queries 126A-n and suchlike can be leveraged to increase the efficiency/cost/timeliness of FMEA/HACCP/product review. For example, as a FMEA review is being performed, respective information can be submitted to/obtained by IMS 110. By utilizing IMS 110 to assist with FMEA review, potential problems and their effects can be identified and addressed pre-emptively.

Turning to FIG. 5, system 500 presents systems and components that can be utilized to assist with product review/design operations such as FMEA/HACCP, in accordance with one or more embodiments. System 500 includes various components as previously described in FIG. 1. However, rather than IMS 110 interacting with an operator 105, with system 500, IMS 110 is interacting with a product design system 502 (e.g., operated by a design engineer updating a design of component 103). During design of part 103, FMEA/HACCP/product review/design processes and procedures can be performed. For example, during design of part 103, one or more members of an engineering/design team can generate/interact with part information and design data (PIDD) 503, whereby PIDD 503 can include/comprise any information pertaining to design and manufacture of part 103, e.g., drawings, material specifications, heat treatment, quality control requirements, etc. In an aspect, PIDD 503 can include information regarding FMEA/HACCP requirements/compliance.

Accordingly, as design of part 103 proceeds, design data 507A-n comprising dimensions, material information, FMEA/HACCP pertinent information, and the like, can be submitted into IMS 110. Similar to how a query 107A-n is reviewed, as previously described, content of FMEA/HACCP data 507A-n can be analyzed by one or more components included in IMS 110, and further compared with operational data 125A-n and prior queries 126A-n, wherein the operational data 125A-n and prior queries 126A-n can also include data such as FMEA/HACCP/design data 530A-n regarding design and failure analysis of part 103 (and related parts, e.g., materials available to fabricate part 103 with, including physical properties of the materials, mechanical properties of the materials, heat treatment, failure analysis information, and suchlike). In an embodiment, as a design engineer makes an update/change (e.g., design input/change/update 504A-n) to a design of component 103, updated design data 507A-n can be generated and forwarded to IMS 110 for comparison with operational data 125A-n/prior queries 126A-n, FMEA/design data 530A-n, etc. In another embodiment, the product design system 502 can be configured to automatically perform one or more iterations (e.g., design input/change/update 504A-n) to the design of component 103, whereby, as an iteration is performed, updated design data 507A-n is automatically compiled by the product design system 502 and forwarded for analysis at IMS 110.

Hence, as information (e.g., design input/change/update 504A-n) is supplied to the design/info sheet 503 and/or into the product design system 502, and further received at IMS 110, information pertaining to FMEA/HACCP requirements/compliance can be extracted, parsed (e.g., by format component 122) into a format suitable for analysis (e.g., a vectorized format), and compared (e.g., by search component 130 and pairing component 140) with information in operational data 125A-n, prior queries 126A-n, and/or FMEA/design data 530A-n, pertaining to FMEA/HACCP requirements/compliance. Based on a potential match(es) between FMEA/HACCP-related information in the design/info sheet 503 and FMEA/HACCP-related information 530A-n in the operational data 125A-n and prior queries 126A-n, IMS 110 can be configured to notify (e.g., in an issue/recommendation notification 197A-n) the design team (e.g., at product design system 502) of the potential identified issue 509A-n. Accordingly, as design of part 103 proceeds (e.g., per design input/change/update 504A-n), the FMEA/HACCP-related corpus of knowledge 530A-n acquired in operational data 125A-n and prior queries 126A-n can be provided to the design team (e.g., at product design system 502) in a timely manner, thereby bringing to the attention of the design team, one or more FMEA/HACCP-related issues (e.g., issues/recommendations 509A-n in FMEA/design data 530A-n) pertaining to design of part 103. Further, by IMS 110 being configured to raise FMEA/HACCP-related issues, IMS 110 may raise issues/recommendations 509A-n that the design team have not considered, and further, a solution 127A-n (e.g., as part of a recommendation 509A-n) provided in operational data 125A-n and prior queries 126A-n (e.g., as utilized previously by a different company) may offer a solution to the FMEA/HACCP-related issue that improves the manufacture of part 103, whereby the improvement was previously unknown to the design team.

As part of the design and data entry (e.g., design input/change/update 504A-n) in the design/info sheet 503, various attributes (e.g., relating to machining of part 103, materials selected to comprise part 103, implementation of part 103, etc.) can be entered in the design/info sheet 503 along with various requirements/endpoints. IMS 110 can review the respective attributes, requirements, endpoints, etc., and determine whether the respective attributes, requirements, endpoints, etc., can be met with the design of part 103 and further, how they can be met, or modifications to the design to enable the requirements to be met, if at all. Again, IMS 110 can be configured to determine similar attributes, requirements, endpoints, etc., in the operational data 125A-n and prior queries 126A-n, and generate notifications/recommendations 509A-n, based thereon. Accordingly, IMS 110 can perform in a proactive manner to prevent one or more failure modes arising for part 103, and further, guide the design team to design part 103 as efficiently and safely as possible.

Further, utilizing the FMEA/HACCP-related knowledge 530A-n available in IMS 110 (e.g., in operational data 125A-n and prior queries 126A-n), the design process for part 103 is no longer reliant on the knowledge of a particular employee (e.g., the retiring machinist, a retiring design engineer) as the employee's knowledge will be captured and available in operational data 125A-n and prior queries 126A-n stored in database system 120.

It is to be appreciated that while interaction between IMS 110 and product design system 502 is via FMEA/HACCP data 507A-n being provided to/obtained by the IMS 110 (e.g., as data packets), the FMEA/HACCP data 507A-n can be provided in the form of statements/questions (e.g., in a query 107A-n) generated by an engineer associated with the product design system 502.

Hence, per the various embodiments presented herein, capturing and utilizing information stored in the knowledge base of the IMS 110 can be beneficial to a manufacturing entity with regard to less errors, less waste, higher production throughput, and suchlike.

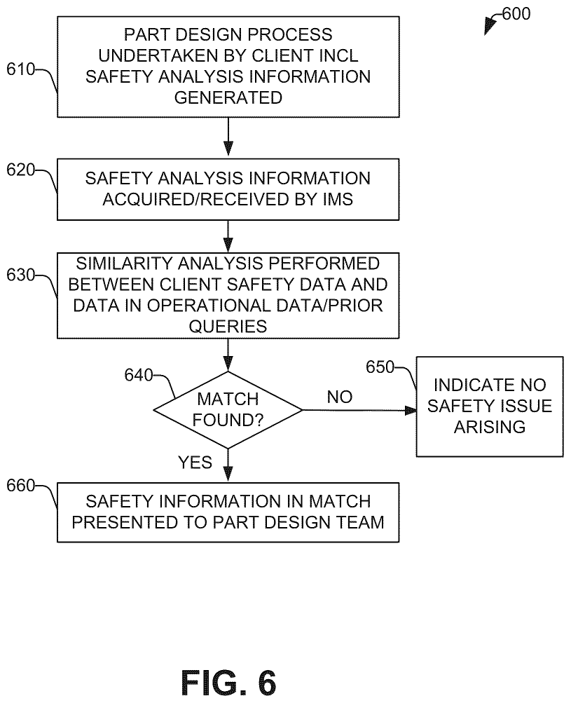

FIG. 6 presents a computer-implemented methodology 600 for automatically designing a component/part/device while being in accordance/cognizant of respective safety issues/requirements pertaining to design and implementation of the part, in accordance with an embodiment.

At 610, design of a part (e.g., part 103) can be initiated/undertaken by a design team. In an embodiment, the design process can include safety review/analysis to minimize risk of failure etc., regarding implementation/use of part 103. As mentioned, the design process can be cognizant of FMEA/HACCP-related issues, wherein the FMEA/HACCP-related information can be included in a product design knowledgebase (e.g., in design/info sheet 503).

At 620, the FMEA/HACCP-related information (e.g., in FMEA/design data 507A-n) can be acquired by/provided to an IMS 110, wherein the FMEA/HACCP-related information can be parsed/formatted as required at the IMS 110 to enable similarity matching/determination of other existing data (e.g., operational data 125A-n and prior queries 126A-n) available at IMS 110, whereby IMS 110 can function as a cloud-based central data repository of manufacturing information.

At 630, similarity analysis can be performed by IMS 110 to identify one or more items of operational data 125A-n, prior queries 126A-n, prior FMEA/design data 530A-n that pertain to FMEA/HACCP-related design information 507A-n in the design/info sheet 503.

At 640, in response to a determination by IMS 110 that NO operational data 125A-n/prior queries 126A-n matches the FMEA/HACCP-related information, methodology 600 can advance to 650, whereupon a notification (e.g., issue notification 509A-n in communication 197N) can be provided to the design team that no FMEA/HACCP issue is present for the specific design/attribute of part 103 and/or no pertinent FMEA/HACCP-related information has been found (e.g., operational data 125A-n, prior queries 126A-n, prior FMEA/design data 530A-n).

At 640, in response to a determination by IMS 110 that YES, FMEA/HACCP-related information has been identified in the operational data 125A-n, prior queries 126A-n, prior FMEA/design data 530A-n, methodology 600 can advance to 660, whereupon the FMEA/HACCP-related issue (e.g., in associated data 127A-n) can be identified and/or a recommendation to address the FMEA/HACCP-related issue can be provided to the design team (e.g., in issue notification/recommendation 509A-n).

### Analysis of SPC Data

In another embodiment, operation of the machine 102 can be monitored and operational data generated during the operation of machine 102 can be acquired/obtained by IMS 110. Hence, as an operational shift occurs (e.g., diameter of part 103), operating condition data 704A-n can be reviewed by the IMS 110 to determine whether operation of the machine 102 may give rise to one or more product quality risks. Hence, operational data 125A-n/prior queries 126A-n can provide a knowledge base to assist in determining risks pertaining to product quality, for example, subsequent processing of part 103 may relate to environmental conditions present during an earlier fabrication stage of part 103 (e.g., environmental humidity when creating a part comprising a plurality of layers of carbon fiber bonded together). Accordingly, during fabrication of a part X, similar to part 103 comprising carbon fiber layers, in the event of the environmental humidity increasing, IMS 110 can be configured to review operational data 125A-n/prior queries 126A-n and identify that part 103 failed as a result of the humidity conditions, accordingly, there is a risk that part X will undergo the same failure mechanism as part 103.

Hence, by monitoring a current or future manufacture of a part, IMS 110 can apply current/historical/future operating conditions to operational data 125A-n/prior queries 126A-n, and based on one or more similarities between current/historical/future operating condition identified in operational data 125A-n/prior queries 126A-n, IMS 110 can be configured to generate a notification of the potential risk, recommend an optimization (e.g., any of a process, people, machine, etc.) to prevent the loss of quality.

A plethora of factors can be utilized by/input into the IMS 110 (e.g., via screens 187A-n, direct inputs from product design systems (e.g., product design system 502), direct inputs from monitoring systems (e.g., monitoring system 710), any computer system communicatively coupled to IMS 110, and such like), including process checksheet inputs (e.g., qualitative, such as visual inspection, and/or quantitative, such as measurements/dimensions of a part), statistical process control (SPC) data, machine settings, operation/run parameters, inventory outputs and status', operator skills and training, environmental data, materials data, equipment manufacturer specifications, and suchlike.

For example, SPC data can be acquired regarding part 103 as it is currently being fabricated, whereby the SPC data can be submitted into/acquired by IMS 110 and compared with SPC data present in operational data 125A-n and/or queries 126A-n. Operational data 125A-n can be identified that is similar to the current SPC data, and based thereon, IMS 110 can generate an issue notification/recommendation 509A-n regarding the identified SPC data present in operational data 125A-n. Accordingly, the recommendation 509A-n can be applied to machine 102 to avert the loss of product quality. Hence, the recommendation 509A-n by IMS 110 can be based on a prediction (generated from the SPC data present in operational data 125A-n) that the process may become problematic if the operating condition of concern is not addressed.

Turning to FIG. 7, system 700 presents systems and components that can be utilized to assist with controlling operation of a process based on operational data captured regarding the process, in accordance with one or more embodiments. System 700 includes various components as previously described in FIG. 1. However, rather than IMS 110 interacting with an operator 105, with system 700, IMS 110 is interacting with a process monitoring system 710. As mentioned, process monitoring system 710 can be configured to capture a plethora of measurements/data (e.g., conditions 704A-n) regarding operation of machine 102, e.g., during fabrication of a part. In an embodiment, monitoring system 710 can be configured to generate SPC data 707A-n regarding current/historical/future operating conditions 704A-n at machine 102. IMS 110 can be configured to acquire/receive the SPC data 707A-n, parse and format the SPC data 707A-n, as required for data analysis by IMS 110, and further determine whether operating conditions 704A-n/SPC data 707A-n is indicative of a potential product quality issue may arise at machine 102. In an embodiment, operating conditions 704A-n/SPC data 707A-n can be compared by the IMS 110 with quality control/operating condition data in operational data 125A-n, queries 126A-n, and/or prior SPC data 730A-n (as acquired from resources 190A and 190B). Based on similarity analysis, one or more conditions in operational data 125A-n and/or queries 126A-n can be determined to be similar to operating conditions 704A-n/SPC data 707A-n, and further, for example, the identified one or more conditions in operational data 125A-n also have related quality issues/recommendations, e.g., in associated data 127A-n. Accordingly, IMS 110 can generate an issue notification/recommendation 709A-n (e.g., per notification 197N) for implementation on machine 102 to prevent a quality control issue from occurring/become worse.

It is to be appreciated that while interaction between IMS 110 and monitoring system 710 is via SPC data 707A-n being provided to/obtained by the IMS 110 (e.g., as data packets), the SPC data 707A-n can be provided in the form of statements/questions (e.g., in a query 107A-n) generated by an engineer associated with the monitoring system 710.

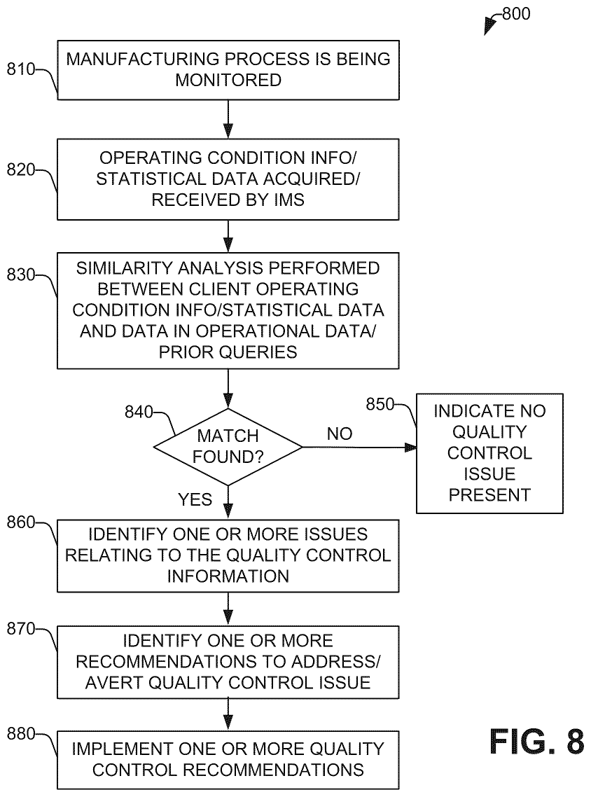

FIG. 8 presents a computer-implemented methodology 800 for automatically predicting/addressing a quality control issue pertaining to a manufacturing process, in accordance with an embodiment.

At 810, operation of machine 102 is being monitored by a monitoring system 710. Operating condition data 704A-n can be acquired by the monitoring system 710, in an example, the operating condition data 704A-n can pertain to fabricating part 103 or part similar thereto.

At 820, operating condition data 704A-n and statistical data (e.g., SPC data 707A-n) generated by the monitoring system 710 can be acquired by/provided to an IMS 110, wherein the operating condition data 704A-n/SPC data 707A-n can be parsed/formatted as required at the IMS 110 to enable similarity matching/determination of other existing data (e.g., operational data 125A-n, prior queries 126A-n, and/or prior SPC data 730A-n) available at IMS 110, whereby IMS 110 can function as a cloud-based central data repository of manufacturing information.

At 830, similarity analysis can be performed by IMS 110 (e.g., by pairing component 140) to identify one or more items of operational data 125A-n, prior queries 126A-n, and/or prior SPC data 730A-n that pertain to operating condition data 704A-n/SPC data 707A-n.

At 840, in response to a determination by IMS 110 that NO operational data 125A-n, prior queries 126A-n, and/or prior SPC data 730A-n matches the operating condition data 704A-n/SPC data 707A-n, methodology 800 can advance to 850, whereupon a notification (e.g., issue notification 709A-n in notification 197N) can be provided (e.g., by response component 150) to the design team/monitoring system 710 that no quality control issue is present for the current operating conditions at machine 102 regarding part 103.

At 840, in response to a determination by IMS 110 that YES, operating condition data 704A-n/SPC data 707A-n-related information has been identified in the operational data 125A-n/prior queries 126A-n, methodology 800 can advance to 860, whereupon the IMS 110 (e.g., pairing component 140) can be configured to review operational data 125A-n, prior queries 126A-n, and/or prior SPC data 730A-n for related issues (e.g., quality control issues).

At 870, one or more recommendations to address/avert the identified issues can be identified by IMS 110, e.g., whereby IMS 110 (e.g., pairing component 140) can review actions performed/relating to the identified issues in operational data 125A-n, prior queries 126A-n, and/or prior SPC data 730A-n.

At 880, IMS 110 (e.g., response component 150) can be configured to generate/transmit one or more recommendations 709A-n (e.g., in a notification 197R) regarding how to adjust operation condition(s) (e.g., operating conditions 704A-n) at machine 102 to mitigate the predicted quality control issue, e.g., regarding manufacture of component 103.

In an embodiment, the IMS 110 can include a trend component 780 configured to determine a trend in the operating condition data 704A-n/SPC data 707A-n and based on one or more identified trends in operational data 125A-n, prior queries 126A-n, and/or prior SPC data 730A-n, IMS 110 can avert the quality issue. For example, if the operating condition is trending towards a quality control concern that previously occurred at a parameter P having a value of 100 in operating conditions 704A-n, trend component 780 can be further configured to identify/recommend one or more operating conditions to be implemented when the current value of parameter P is at a percentage (e.g., 80%) of the parameter value when the quality control issue arose. Hence, by identifying respective trends in operating condition data 704A-n/SPC data 707A-n and in operational data 125A-n, prior queries 126A-n, and/or prior SPC data 730A-n, trend component 780/IMS 110 (e.g., in conjunction with process component 195/processes 196A-n) can be configured to pre-emptively mitigate the occurrence of an issue 709A-n, and/or provide a recommendation to address issue 709A-n prior to the issues issue 709A-n deleteriously affecting manufacture of component 103.

### Response Priority and Response Combination

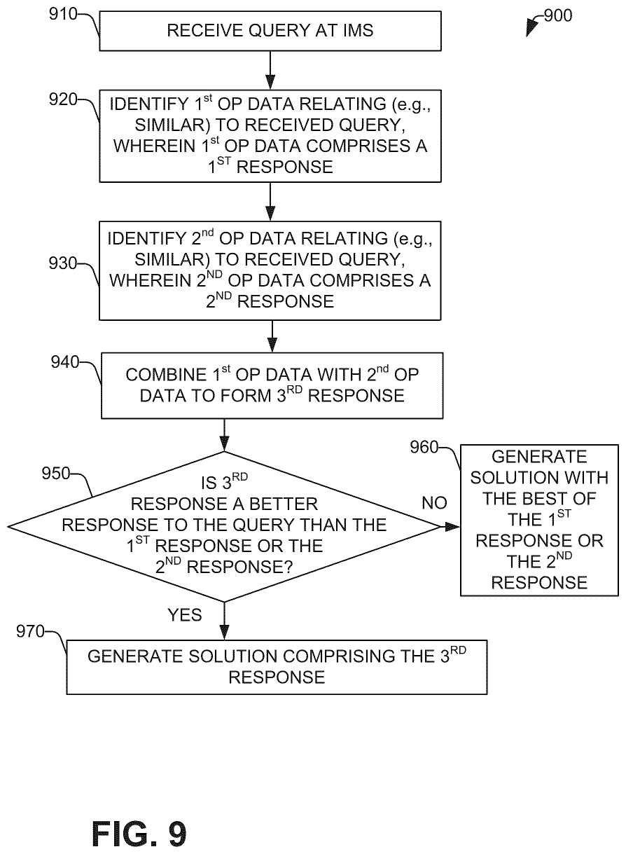

FIG. 9 presents a computer-implemented methodology 900 for generating query responses based on combining information/data in a knowledge base, in accordance with an embodiment.

At 910, a query 107A is received at IMS 110 (e.g., at IMS component 112, at format component 122), wherein query 107A relates to an issue 104A-n.

At 920, a first operational data 125A (or prior query 126A) is identified (e.g., by search component 130/pairing component 140) as being pertinent (similar) to the content of query 107A, whereby first operational data 125A is mapped (e.g., by pairing component 140) to a first solution 127A.

At 930, a second operational data 125B (or prior query 126B) is identified as being pertinent (similar) to the content of query 107A, whereby second operational data 125B is mapped (e.g., by pairing component 140) to a second solution 127B.

At 940, the first operational data 125A and second operational data 125B (and associated first solution 127A and second solution 127B) can be combined (e.g., by pairing component 140) to create a third solution 127C.

At 950, IMS 110 can determine (e.g., by pairing component 140, process component 195, processes 196A-n) which of the first solution 127A, second solution 127B, and/or third solution 127C best respond to/address content of query 107A. In response to a determination of NO, the third solution 127C does not improve on the first solution 127A or second solution 127B, methodology 900 can advance to step 960, whereupon the first solution 127A or second solution 127B can be further assessed to determine (e.g., by pairing component 140, process component 195, processes 196A-n) which best responds to the query 107A, and accordingly, the best of solutions 127A and 127B can be provided in a response 109A-n to the operator 105. In an embodiment, both solutions 127A and 127B can be provided, whereby response 109A can state “try solution 127B first, and if that does not work, then try solution 127C”. Whereupon the respective solutions can be implemented with operator 105 reporting back (e.g., in a subsequent query 107B) to IMS 110 as to which of the solutions 127A, 127B, and/or 127C worked, with database 120 being updated accordingly, as previously mentioned.

Further at 950, in response to a determination that YES, the third solution 127C improves on the first solution 127A and the second solution 127B, methodology 900 can advance to step 970, whereupon the third solution 127C can be provided in response 109A to operator 105.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Per the various embodiments presented herein, various components included in the IMS 110, IMS component 112, format component 122, search component 130, pairing component 140, response component 150, process component 195, interface component 116, and suchlike, can include AI and ML and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process (e.g., by IMS component 112 in conjunction with pairing component 140) for identifying a solution 127A-n to a query 107A-n/issue 104A-n, a similar process to predict a quality control status of a system (e.g., machine 102) based on comparison of current operating conditions/statistical trend (e.g., at machine 102) versus historical SPC data 125A-n, similarly FMEA analysis during product design, and suchlike, as previously mentioned herein, can be facilitated via an automatic classifier system and process.

A classifier is a function that maps an input attribute vector, x=(x1, x2, x3, x4, xn), to a class label class (x). The classifier can also output a confidence that the input belongs to a class, that is, f(x)=confidence (class (x)). Such classification can employ a probabilistic and/or statistical-based analysis (e.g., factoring into the analysis utilities and costs) to prognose or infer an action that a user desires to be automatically performed (e.g., identifying a solution to a manufacturing issue 104A-n, based on historical data 125A-n/126A-n pooled in a multi-tenant knowledge base, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, probability of an having previously worked on an issue similar to the unresolved issue, for example.

As described supra, inferences can be made, and automated operations performed, based on numerous pieces of information. For example, whether a potential solution 127A-n is applicable to an issue 104A-n, whether the solution 127A-n addressed the issue 104A-n, whether any of an issue 104A-n, a FMEA/HACCP condition 507A-n, SPC data 707A-n, and suchlike, have been correctly paired with operational data 125A-n/prior queries 126A-n, searches 132A-n correctly generated, thresholds 142A-n met, recommendations 109A-n, 509A-n, 709A-n, have been correctly determined, work instructions 106A-n are correct/understandable, and suchlike.

### General System Configuration

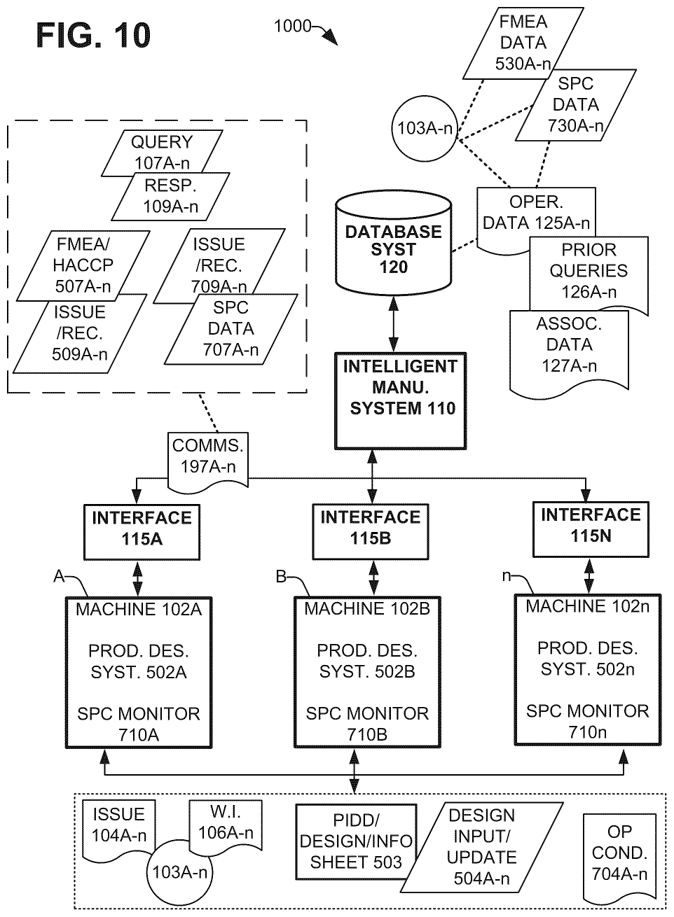

FIG. 10 presents a schematic of a system 1000 illustrating a configuration of a cloud-based IMS with multiple entities communicatively coupled thereto, in accordance with an embodiment. As previously mentioned, IMS 110 can receive queries 107A-n, FMEA data 507A-n, and/or SPC data 707A-n from one or more remotely institutions A-n such as one or more manufacturing entities, research center, design center, and suchlike, (e.g., machine 102A-n, product design system 502A-n, SPC monitoring system 710A-n). The manufacturing entity, etc., can be located local to IMS 110, e.g., wherein the manufacturing plant (e.g., including any of local machine 102A-n, local product design system 502A-n, local SPC monitoring system 710A-n) can be co-located with IMS 110. In an alternative embodiment, IMS 110 can be remotely located from a manufacturing plant, design center, etc., whereby the IMS 110 can be configured to receive and process data (e.g., queries 107A-n, FMEA data 507A-n, and/or SPC data 707A-n) and generate responses 109A-n, issues/recommendations 509A-n, and/or issues/recommendations 709A-n. Accordingly, any of the manufacturing plants, research centers, design centers, etc., can generate and transmit data for processing at IMS 110, such that data (e.g., queries 107A-n, FMEA data 507A-n, and/or SPC data 707A-n) can be sourced from operations being performed locally (e.g., at the same manufacturing/business location), regionally (e.g., from various manufacturing/business locations in the same state, county, country, etc.), and/or globally (e.g., from manufacturing/business locations located in different countries, continents, etc.). As further mentioned, the respective manufacturing/business entities can be owned/operated by the same company/entity, or can be owned/operated by different companies/entities, such that a first company owns/operates machine 102A and SPC monitoring system 710A at location A, a second company owns/operates machine 102B and SPC monitoring system 710B at location B, with design research being performed by a third entity (e.g., a university) using product design system 502C located at location C. Hence, knowledge can be sourced from multiple entities, whereby IMS 110 can operate with data provided by a single entity, through to IMS 110 being a global operation processing data from entities located across the globe, with the entities being from the same organization/business/company or from disparate organizations/businesses/companies.

### Further Methods

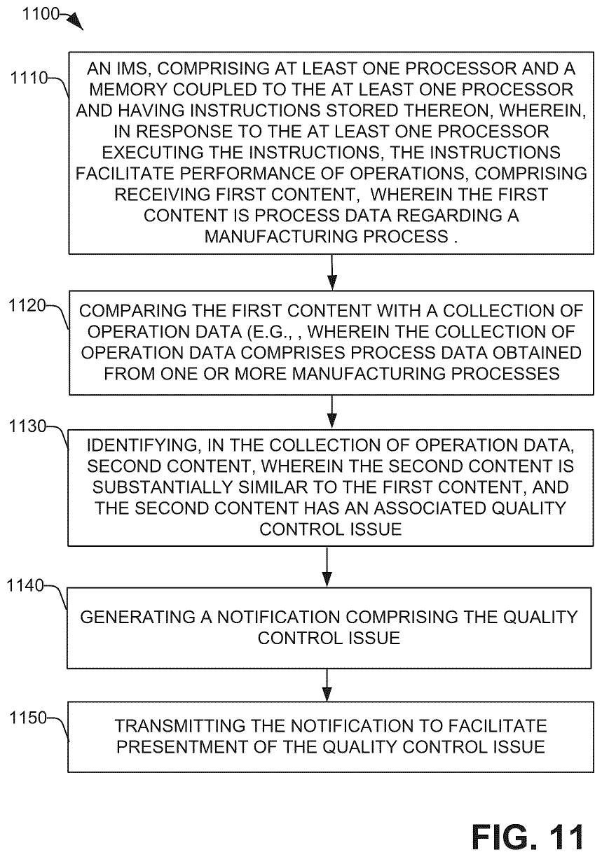

FIG. 11, via flowchart 1100, presents an example computer-implemented method for automatically and dynamically identifying prior process control data pertaining to current operation of the manufacturing process to enable identification of a quality control issue pertaining to the current operation, in accordance with an embodiment.

At 1110, method 1100 can be performed by an IMS (e.g., IMS 110), comprising at least one processor (e.g., processor 182A-n) and a memory (e.g., memory 184A-n) coupled to the at least one processor and having instructions stored thereon, wherein, in response to the at least one processor executing the instructions, the instructions facilitate performance of operations, comprising receiving first content (e.g., SPC data 707A-n), wherein the first content is process data regarding a manufacturing process (e.g., operating condition data 704A-n of machine 102).

At 1120, method 1100 can further comprise comparing (e.g., in a search 132A-n) the first content with a collection of operation data (e.g., operational data 125A-n, prior queries 126A-n, SPC data 730A-n), wherein the collection of operation data comprises process data obtained from one or more manufacturing processes (e.g., process A-n in FIG. 10).

At 1130, method 1100 can further comprise identifying, in the collection of operation data, second content (e.g., operational data 125A-n, prior queries 126A-n, SPC data 730A-n, associated data 127A-n), wherein the second content is substantially similar to the first content, and the second content has an associated quality control issue (e.g., issue 709A-n).

At 1140, method 1100 can further comprise generating a notification (e.g., communication 197N) comprising the quality control issue.

At 1150, method 1100 can further comprise transmitting the notification to facilitate presentment of the quality control issue.

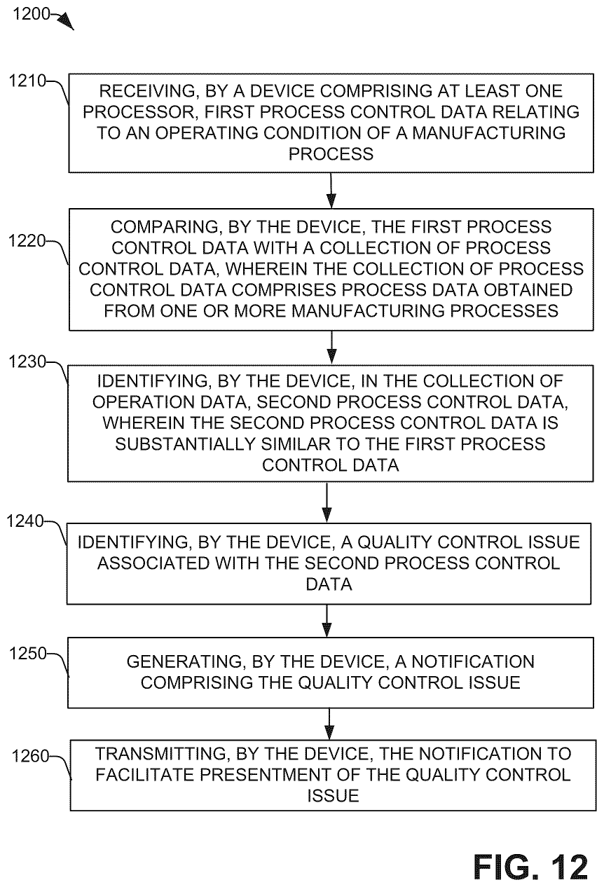

FIG. 12, via flowchart 1200, presents an example computer-implemented method for automatically and dynamically identifying prior process control data pertaining to current operation of the manufacturing process to enable identification of a quality control issue pertaining to the current operation, in accordance with an embodiment.

At 1210, method 1200 can comprise receiving, by a device (e.g., IMS component 112) comprising at least one processor (e.g., processor 182), first process control data (e.g., SPC data 707A-n) relating to an operating condition of a manufacturing process (e.g., machine 102).

At 1220, method 1200 can further comprise comparing (e.g., in a search 132A-n), by the device, the first process control data with a collection of process control data (e.g., operational data 125A-n, prior queries 126A-n, SPC data 730A-n, associated data 127A-n), wherein the collection of process control data comprises process data obtained from one or more manufacturing processes (e.g., process A-n in FIG. 10).

At 1230, method 1200 can further comprise identifying, by the device, in the collection of operation data, second process control data (e.g., in any of operational data 125A-n, prior queries 126A-n, SPC data 730A-n, associated data 127A-n), wherein the second process control data is substantially similar to the first process control data.

At 1240, method 1200 can further comprise identifying, by the device, a quality control issue (e.g., issue 709A-n) associated with the second process control data.

At 1250, method 1200 can further comprise generating, by the device, a notification (e.g., communication 197N) comprising the quality control issue.

At 1260, method 1200 can further comprise transmitting, by the device, the notification to facilitate presentment of the quality control issue.

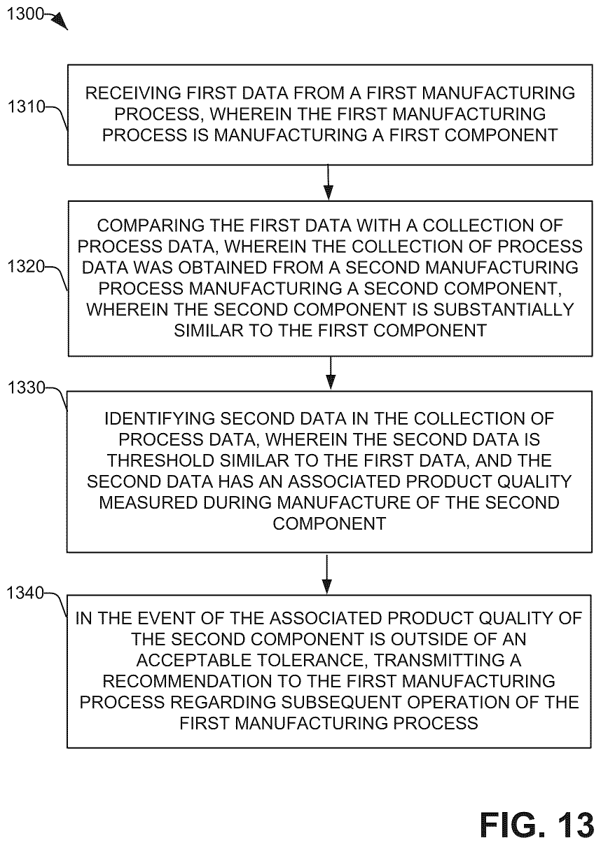

FIG. 13, via flowchart 1300, presents an example computer-implemented method for automatically and dynamically identifying prior process control data pertaining to current operation of the manufacturing process to enable identification of a quality control issue pertaining to the current operation, in accordance with an embodiment.

At 1310, method 1300 can comprise receiving first data (e.g., SPC data 707A-n) from a first manufacturing process (e.g., manufacturing process at machine 102), wherein the first manufacturing process is manufacturing a first component (e.g., component 103A).

At 1320, method 1300 can further comprise comparing (e.g., in a search 132A-n) the first data with a collection of process data (e.g., operational data 125A-n, prior queries 126A-n, SPC data 730A-n, associated data 127A-n), wherein the collection of process data was obtained from a second manufacturing process (e.g., machine 102B) manufacturing a second component (e.g., component 103B), wherein the second component is substantially similar to the first component.

At 1330, method 1300 can further comprise identifying second data (e.g., in any of operational data 125A-n, prior queries 126A-n, SPC data 730A-n, associated data 127A-n) in the collection of process data, wherein the second data is threshold similar to the first data, and the second data has an associated product quality measured during manufacture of the second component.

At 1340, method 1300 can further comprise in the event of the associated product quality of the second component is outside of an acceptable tolerance, transmitting a recommendation (e.g., recommendation 709A-n) to the first manufacturing process regarding subsequent operation of the first manufacturing process.

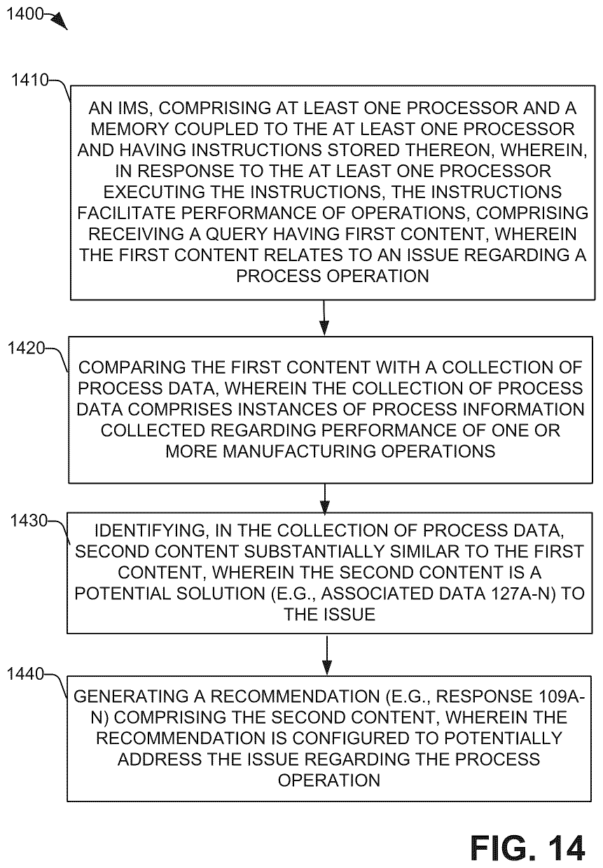

FIG. 14, via flowchart 1400, presents an example computer-implemented method for automatically and dynamically identifying information pertaining to content in a query, in accordance with an embodiment.

At 1410, method 1400 can be performed by an IMS (e.g., IMS 110), comprising at least one processor (e.g., processor 182A-n) and a memory (e.g., memory 184A-n) coupled to the at least one processor and having instructions stored thereon, wherein, in response to the at least one processor executing the instructions, the instructions facilitate performance of operations, comprising receiving a query (e.g., query 107A) having first content, wherein the first content relates to an issue (e.g., issue 104A) regarding a process operation (e.g., of machine 102).

At 1420, method 1400 can further comprise comparing (e.g., in a search 132A-n) the first content with a collection of process data (e.g., operational data 125A-n, prior queries 126A-n, associated data 127A-n), wherein the collection of process data comprises instances of process information collected regarding performance of one or more manufacturing operations (e.g., performed at machines 102A-n).

At 1430, method 1400 can further comprise identifying, in the collection of process data, second content (e.g., in any of operational data 125A-n, prior queries 126A-n, associated data 127A-n) substantially similar to the first content, wherein the second content is a potential solution (e.g., associated data 127A-n) to the issue.

At 1440, method 1400 can further comprise generating a recommendation (e.g., response 109A-n) comprising the second content, wherein the recommendation is configured to potentially address the issue regarding the process operation.

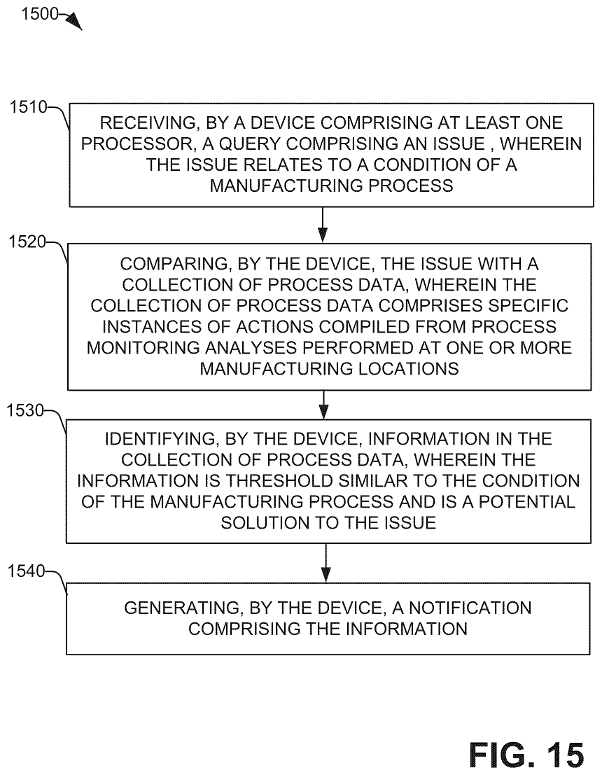

FIG. 15, via flowchart 1500, presents an example computer-implemented method for automatically and dynamically determining process information having the potential to address an issue presented in a query, in accordance with an embodiment.

At 1510, method 1500 can comprise receiving, by a device (e.g., IMS 110) comprising at least one processor (e.g., processor 182A-n), a query (e.g., query 107A) comprising an issue (e.g., issue 104A), wherein the issue relates to a condition of a manufacturing process (e.g., operation of machine 102).

At 1520, method 1500 can further comprise comparing (e.g., in a search 132A-n), by the device, the issue with a collection of process data (e.g., operational data 125A-n, prior queries 126A-n, associated data 127A-n), wherein the collection of process data comprises specific instances of actions compiled from process monitoring analyses performed at one or more manufacturing locations.

At 1530, method 1500 can further comprise identifying, by the device, information (e.g., any of operational data 125A-n, prior queries 126A-n, associated data 127A-n) in the collection of process data, wherein the information is threshold similar (e.g., per threshold 142A-n) to the condition of the manufacturing process and is a potential solution to the issue.

At 1540, method 1500 can further comprise generating, by the device, a notification (e.g., response 109A-n) comprising the information.

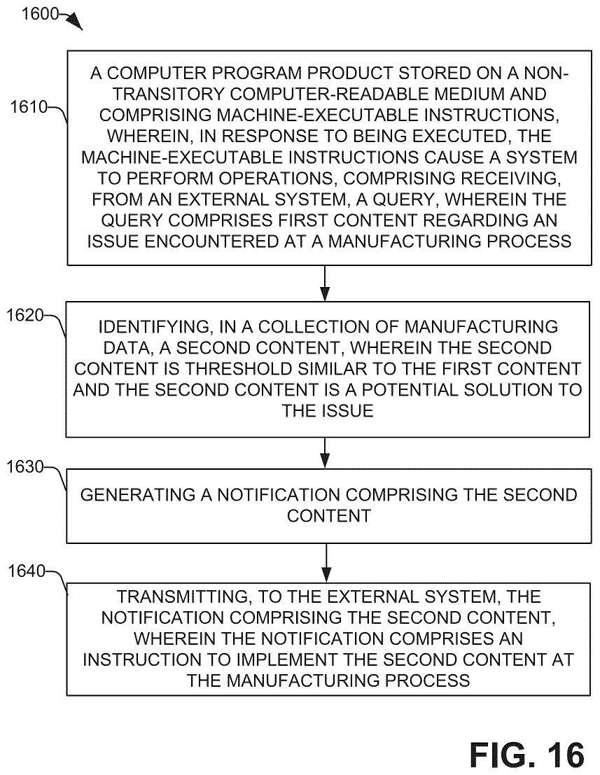

FIG. 16, via flowchart 1600, presents an example computer-implemented method for automatically and dynamically identifying information pertaining to a query regarding a manufacturing process, in accordance with an embodiment.

At 1610, method 1600 can be performed with a computer program product stored on a non-transitory computer-readable medium (e.g., memory 184A-n) and comprising machine-executable instructions, wherein, in response to being executed (e.g., by processor 182A-n), the machine-executable instructions cause a system (e.g., IMS 110) to perform operations, comprising receiving, from an external system (e.g., interface 115), a query (e.g., query 107A-n), wherein the query comprises first content regarding an issue e.g., issue 104A) encountered at a manufacturing process (e.g., machine 102).

At 1620, method 1600 can further comprise identifying, in a collection of manufacturing data (e.g., any of operational data 125A-n, prior queries 126A-n, associated data 127A-n), a second content, wherein the second content is threshold (e.g., threshold 142A-n) similar to the first content and the second content is a potential solution to the issue.

At 1630, method 1600 can further comprise generating a notification (e.g., response 109A-n, communication 197N) comprising the second content.

At 1640, method 1600 can further comprise transmitting, to the external system, the notification comprising the second content, wherein the notification comprises an instruction to implement the second content at the manufacturing process.

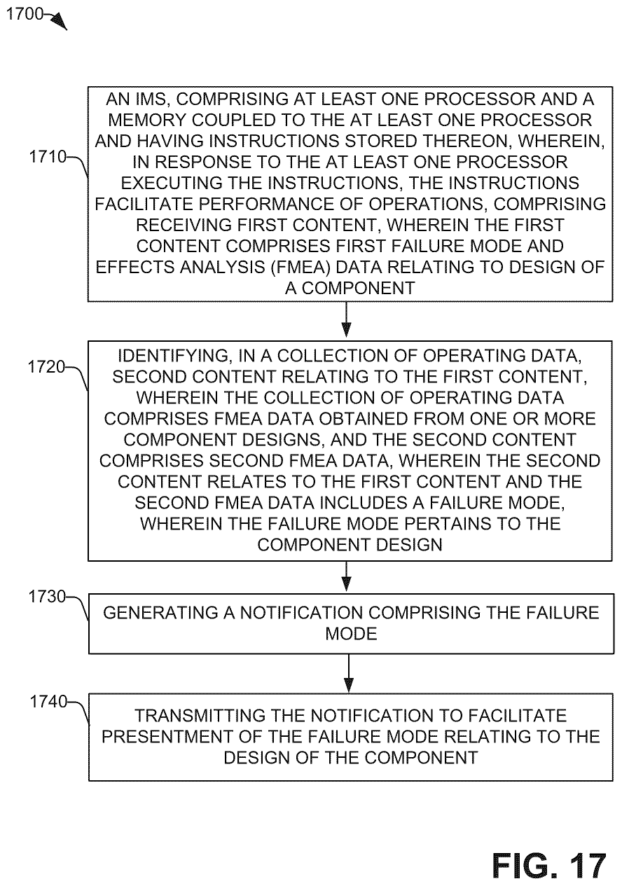

FIG. 17, via flowchart 1700, presents an example computer-implemented method for automatically and dynamically identifying a potential failure mode relating to FMEA data identified during design of a component, in accordance with an embodiment.

At 1710, method 1700 can be performed by an IMS (e.g., IMS 110), comprising at least one processor (e.g., processor 182A-n) and a memory (e.g., memory 184A-n) coupled to the at least one processor and having instructions stored thereon, wherein, in response to the at least one processor executing the instructions, the instructions facilitate performance of operations, comprising receiving first content (e.g., FMEA data 507A-n from product design system 502), wherein the first content comprises first FMEA data relating to design of a component (e.g., component 103A).

At 1720, method 1700 can further comprise identifying, in a collection of operating data (e.g., operational data 125A-n, prior queries 126A-n, associated data 127A-n, FMEA data 530A-n), second content relating to the first content, wherein the collection of operating data comprises FMEA data obtained from one or more component designs (e.g., components 103A-n), and the second content comprises second FMEA data, wherein the second content relates to the first content and the second FMEA data includes a failure mode (e.g., issue 509A-n), wherein the failure mode pertains to the component design (e.g., design of component 103A).

At 1730, method 1700 can further comprise generating a notification (e.g., communication 197N) comprising the failure mode.

At 1740, method 1700 can further comprise transmitting the notification to facilitate presentment of the failure mode relating to the design of the component (e.g., presentment of issue 509A at product design system 502).

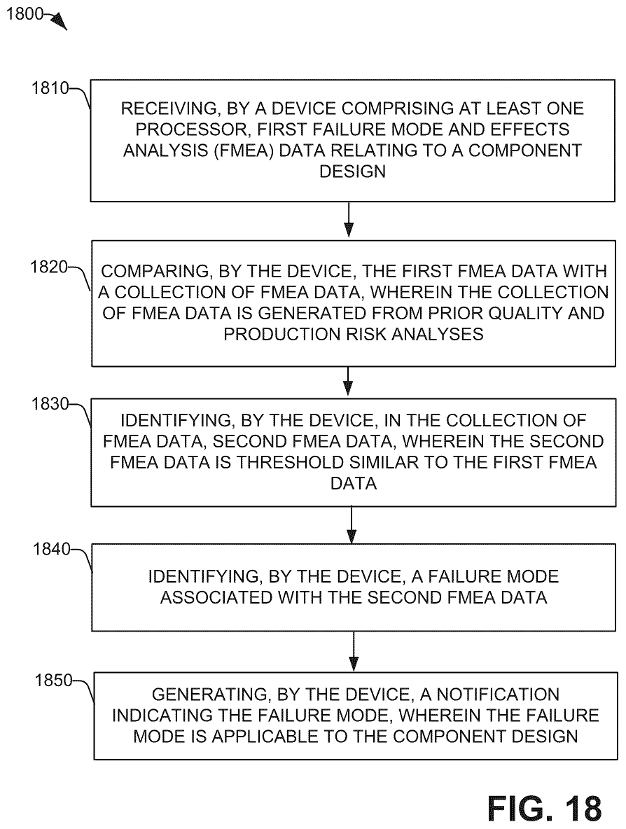

FIG. 18, via flowchart 1800, presents an example computer-implemented method for automatically and dynamically identifying a potential failure mode relating to FMEA data identified during design of a component, in accordance with an embodiment.

At 1810, method 1800 can comprise receiving, by a device (e.g., IMS 110) comprising at least one processor, first FMEA data (e.g., design/FMEA data 507A) relating to a component design (e.g., design of component 103A).

At 1820, method 1800 can further comprise comparing (e.g., per search 132A-n), by the device, the first FMEA data with a collection of FMEA data (e.g., operational data 125A-n, prior queries 126A-n, associated data 127A-n, FMEA data 530A-n), wherein the collection of FMEA data is generated from prior quality and production risk analyses (e.g., of component 103A or other components 103B-n).

At 1830, method 1800 can further comprise identifying, by the device, in the collection of FMEA data, second FMEA data (e.g., associated data 127A-n), wherein the second FMEA data is threshold similar (e.g., per threshold 142A-n) to the first FMEA data.

At 1840, method 1800 can further comprise identifying, by the device, a failure mode (e.g., issue 509A-n) associated with the second FMEA data.

At 1850, method 1800 can further comprise generating, by the device, a notification (e.g., a notification 197N) indicating the failure mode, wherein the failure mode is applicable to the component design.

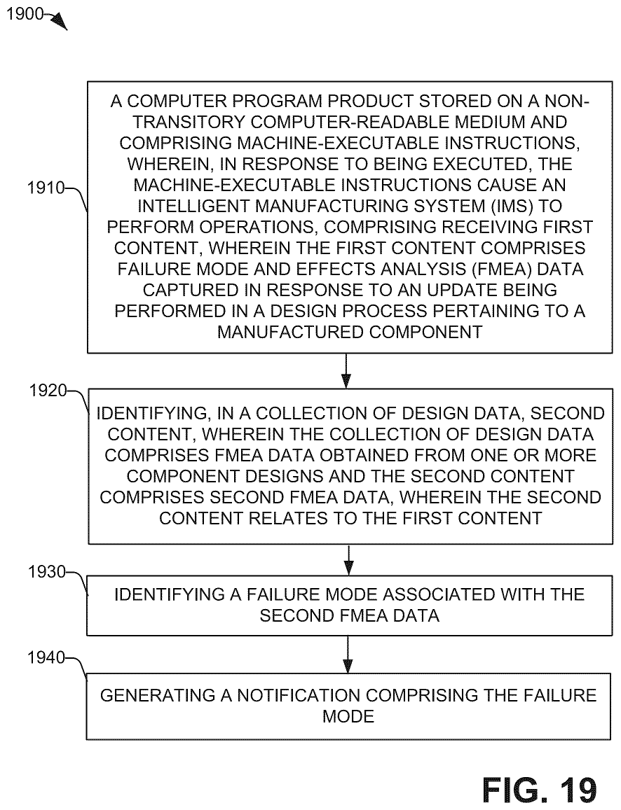

FIG. 19, via flowchart 1900, presents an example computer-implemented method for automatically and dynamically identifying information pertaining to a query regarding a manufacturing process, in accordance with an embodiment.

At 1910, method 1900 can be performed with a computer program product stored on a non-transitory computer-readable medium (e.g., memory 184) and comprising machine-executable instructions, wherein, in response to being executed (e.g., by processor 182), the machine-executable instructions cause an IMS (e.g., IMS 110) to perform operations, comprising receiving first content (e.g., FMEA/design data 507A-n), wherein the first content comprises FMEA data captured in response to an update (e.g., design input/update 504A-n) being performed in a design process pertaining to a manufactured component (e.g., component 103A).

At 1920, method 1900 can further comprise operations regarding identifying (e.g., per search 132A-n), in a collection of design data (e.g., operational data 125A-n, prior queries 126A-n, associated data 127A-n, FMEA data 530A-n), second content, wherein the collection of design data comprises FMEA data obtained from one or more component designs (e.g., components 103A-n) and the second content comprises second FMEA data, wherein the second content relates to the first content.

At 1930, method 1900 can further comprise operations regarding identifying a failure mode (e.g., an issue 509A-n) associated with the second FMEA data.

At 1940, method 1900 can further comprise operations regarding generating a notification (e.g., notification 197N) comprising the failure mode.

### Example Applications and Use

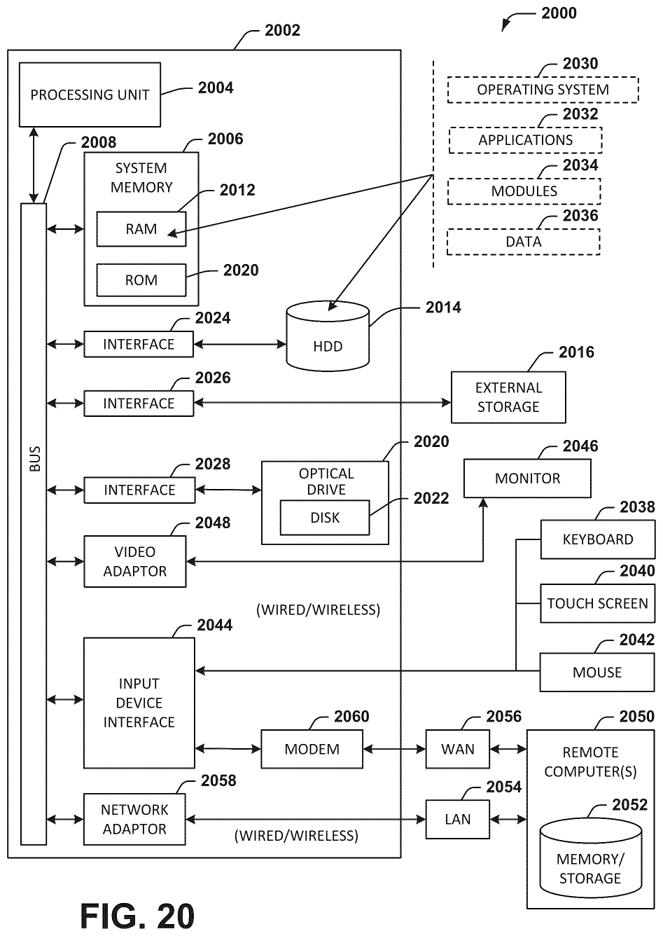

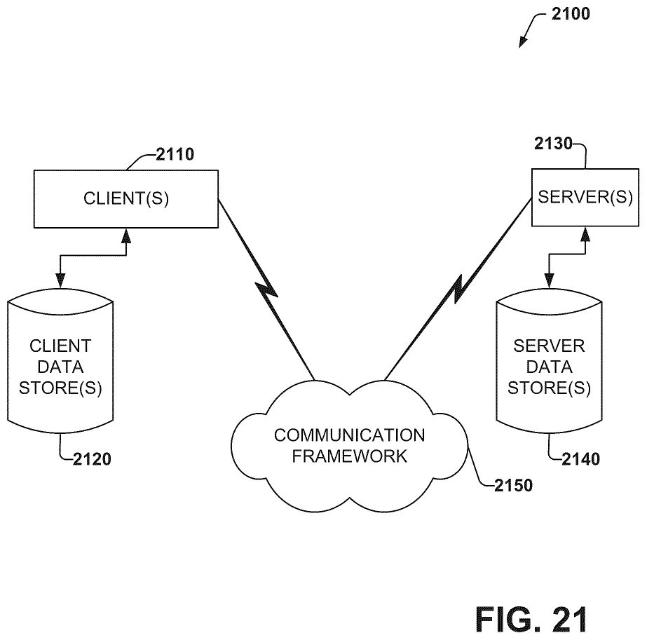

Turning next to FIGS. 20 and 21, a detailed description is provided of additional context for the one or more embodiments described herein with FIGS. 1-19.

In order to provide additional context for various embodiments described herein, FIG. 20 and the following discussion are intended to provide a brief, general description of a suitable computing environment 2000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 20, the example environment 2000 for implementing various embodiments of the aspects described herein includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors and may include a cache memory. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes ROM 2010 and RAM 2012. A basic input/output system (BIOS) can be stored in a non-volatile memory such as ROM, erasable programmable read only memory (EPROM), EEPROM, which BIOS contains the basic routines that help to transfer information between elements within the computer 2002, such as during startup. The RAM 2012 can also include a high-speed RAM such as static RAM for caching data.

The computer 2002 further includes an internal hard disk drive (HDD) 2014 (e.g., EIDE, SATA), one or more external storage devices 2016 (e.g., a magnetic floppy disk drive (FDD) 2016, a memory stick or flash drive reader, a memory card reader, etc.) and an optical disk drive 2050 (e.g., which can read or write from a CD-ROM disc, a DVD, a BD, etc.). While the internal HDD 2014 is illustrated as located within the computer 2002, the internal HDD 2014 can also be configured for external use in a suitable chassis (not shown). Additionally, while not shown in environment 2000, a solid-state drive (SSD) could be used in addition to, or in place of, an HDD 2014. The HDD 2014, external storage device(s) 2016 and optical disk drive 2020 can be connected to the system bus 2008 by an HDD interface 2024, an external storage interface 2026 and an optical drive interface 2028, respectively. The interface 2024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. The systems and methods described herein can be implemented utilizing various commercially available operating systems or combinations of operating systems.

Computer 2002 can optionally comprise emulation technologies. For example, a hypervisor (not shown) or other intermediary can emulate a hardware environment for operating system 2030, and the emulated hardware can optionally be different from the hardware illustrated in FIG. 20. In such an embodiment, operating system 2030 can comprise one virtual machine (VM) of multiple VMs hosted at computer 2002. Furthermore, operating system 2030 can provide runtime environments, such as the Java runtime environment or the .NET framework, for applications 2032. Runtime environments are consistent execution environments that allow applications 2032 to run on any operating system that includes the runtime environment. Similarly, operating system 2030 can support containers, and applications 2032 can be in the form of containers, which are lightweight, standalone, executable packages of software that include, e.g., code, runtime, system tools, system libraries and settings for an application.

Further, computer 2002 can comprise a security module, such as a trusted processing module (TPM). For instance, with a TPM, boot components hash next in time boot components, and wait for a match of results to secured values, before loading a next boot component. This process can take place at any layer in the code execution stack of computer 2002, e.g., applied at the application execution level or at the operating system (OS) kernel level, thereby enabling security at any level of code execution.

A user can enter commands and information into the computer 2002 through one or more wired/wireless input devices, e.g., a keyboard 2038, a touch screen 2040, and a pointing device, such as a mouse 2042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2004 through an input device interface 2044 that can be coupled to the system bus 2008, but can be connected by other interfaces, such as a parallel port, an IEEE 1394 serial port, a game port, a USB port, an IR interface, a BLUETOOTH® interface, etc.

A monitor 2046 or other type of display device can be also connected to the system bus 2008 via an interface, such as a video adapter 2048. In addition to the monitor 2046, a computer typically includes other peripheral output devices (not shown), such as speakers, printers, etc.

The computer 2002 can operate in a networked environment using logical connections via wired and/or wireless communications to one or more remote computers, such as a remote computer(s) 2050. The remote computer(s) 2050 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2052 is illustrated. The logical connections depicted include wired/wireless connectivity to a local area network (LAN) 2054 and/or larger networks, e.g., a wide area network (WAN) 2056. Such LAN and WAN networking environments are commonplace in offices and companies, and facilitate enterprise-wide computer networks, such as intranets, all of which can connect to a global communications network, e.g., the internet.

When used in a LAN networking environment, the computer 2002 can be connected to the local network 2054 through a wired and/or wireless communication network interface or adapter 2058. The adapter 2058 can facilitate wired or wireless communication to the LAN 2054, which can also include a wireless access point (AP) disposed thereon for communicating with the adapter 2058 in a wireless mode.

When used in a WAN networking environment, the computer 2002 can include a modem 2060 or can be connected to a communications server on the WAN 2056 via other means for establishing communications over the WAN 2056, such as by way of the internet. The modem 2060, which can be internal or external and a wired or wireless device, can be connected to the system bus 2008 via the input device interface 2044. In a networked environment, program modules depicted relative to the computer 2002 or portions thereof, can be stored in the remote memory/storage device 2052. It will be appreciated that the network connections shown are examples and other means of establishing a communications link between the computers can be used.

When used in either a LAN or WAN networking environment, the computer 2002 can access cloud storage systems or other network-based storage systems in addition to, or in place of, external storage devices 2016 as described above. Generally, a connection between the computer 2002 and a cloud storage system can be established over a LAN 2054 or WAN 2056 e.g., by the adapter 2058 or modem 2060, respectively. Upon connecting the computer 2002 to an associated cloud storage system, the external storage interface 2026 can, with the aid of the adapter 2058 and/or modem 2060, manage storage provided by the cloud storage system as it would other types of external storage. For instance, the external storage interface 2026 can be configured to provide access to cloud storage sources as if those sources were physically connected to the computer 2002.

The computer 2002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 21 is a schematic block diagram of a sample computing environment 2100 with which the disclosed subject matter can interact. The sample computing environment 2100 includes one or more client(s) 2110. The client(s) 2110 can be hardware or software (e.g., threads, processes, computing devices). The sample computing environment 2100 also includes one or more server(s) 2130. The server(s) 2130 can also be hardware or software (e.g., threads, processes, computing devices). The servers 2130 can house threads to perform transformations by employing one or more embodiments as described herein, for example. One possible communication between a client 2110 and a server 2130 can be in the form of a data packet adapted to be transmitted between two or more computer processes. The sample computing environment 2100 includes a communication framework 2150 that can be employed to facilitate communications between the client(s) 2110 and the server(s) 2130. The client(s) 2110 are operably connected to one or more client data store(s) 2120 that can be employed to store information local to the client(s) 2110. Similarly, the server(s) 2130 are operably connected to one or more server data store(s) 2140 that can be employed to store information local to the servers 2130.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but may not be limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In accordance with an aspect of the disclosure, respective components can execute from various computer readable media having various data structures stored thereon. The components can communicate via local and/or remote processes such as in accordance with a signal having one or more data packets/data sets (e.g., data from one component interacting with another component in a local system, distributed system, and/or across a network such as the Internet with other systems via the signal). In accordance with another aspect of the disclosure, a component can be an apparatus with specific functionality provided by mechanical parts operated by electric or electronic circuitry, which may be operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In accordance with another aspect of the disclosure, a component can emulate an electronic component via a virtual machine, e.g., within a cloud computing system.

In addition, the term “or” may be intended to mean an inclusive “or” rather than an exclusive “or.” That is, unless specified otherwise, or clear from context, “X employs A or B” may be intended to mean any of the natural inclusive permutations. That is, if X employs A; X employs B; or X employs both A and B, then “X employs A or B” may be satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein may not be limited by such examples. In addition, any aspect or design described herein as an “example” and/or “exemplary” may not necessarily to be construed as preferred or advantageous over other aspects or designs, nor it may be meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it may be employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or non-volatile memory or can include both volatile and non-volatile memory. By way of illustration, and not limitation, non-volatile memory can include read only memory (ROM), programmable ROM (PROM), electrically programmable ROM (EPROM), electrically erasable ROM (EEPROM), flash memory, or non-volatile random-access memory (RAM) (e.g., ferroelectric RAM (FeRAM). Volatile memory can include RAM, which can act as external cache memory, for example. By way of illustration and not limitation, RAM may be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” may be interpreted when employed as a transitional word in a claim. The descriptions of the various examples have been presented for purposes of illustration, but are not intended to be exhaustive or limited to the examples disclosed. Many modifications and variations can be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

This written description uses examples to disclose the invention, including the best mode, and to enable any person skilled in the art to practice the invention, including making and using any computing system or systems and performing any incorporated methods. The patentable scope of the invention may be defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Examples of the present disclosure shown in the drawings and described above are example only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described examples can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions require them, but this should not be taken to mean that the features in the dependent claims are mutually exclusive.

What is claimed is:

1. An intelligent manufacturing system (IMS), comprising:
at least one processor; and
a memory coupled to the at least one processor and having instructions stored thereon, wherein, in response to the at least one processor executing the instructions, the instructions facilitate performance of operations, comprising:
receiving first content, wherein the first content is process data regarding a manufacturing process;
comparing the first content with a collection of operation data, wherein the collection of operation data comprises process data obtained from one or more manufacturing processes;
identifying, in the collection of operation data, second content, wherein the second content is substantially similar to the first content, and the second content has an associated quality control issue; and
generating a notification comprising the quality control issue; and
transmitting the notification to facilitate presentment of the quality control issue.

2. The IMS of claim 1, wherein the first content is received from a process monitoring system configured to monitor operation of the manufacturing process.

3. The IMS of claim 1, wherein the quality control issue notification is transmitted to a process monitoring system, wherein the first content was compiled and generated by the process monitoring system.

4. The IMS of claim 1, wherein the operations further comprise:
representing the first content as a first vector;
representing the second content as a second vector; and
determining similarity between the first content and the second content based on a distance between the first vector representation and the second vector representation, wherein similarity is determined based on a similarity threshold.

5. The IMS of claim 1, wherein the IMS is located in a multi-tenant, cloud-based system.

6. The IMS of claim 1, wherein the first content is generated at a first manufacturing operation and the second content is generated at a second manufacturing operation, wherein the first manufacturing operation is located at a first location and the second manufacturing operation is located at a second location, wherein the first location is remotely located to the second location.

7. The IMS of claim 1, wherein the first content comprises at least one of data generated by a product design system, data generated by a process monitoring system, a process checksheet, statistical process control (SPC) data, a machine setting, an operation parameter, inventory data, environmental data, a physical property of a material, a chemical property of a material, or an equipment specification.

8. The IMS of claim 1, wherein the quality control issue notification comprises a first recommendation to adjust operation of the manufacturing process from which the first content is generated or a second recommendation to terminate operation of the manufacturing process from which the first content is generated.

9. The IMS of claim 8, wherein the notification is a first notification and the operations further comprise:
receiving third content, wherein the third content is third process data captured in response to the first recommendation being applied to the manufacturing process;
comparing the third content with the collection of operation data;
identifying, in the collection of operation data, fourth content, wherein the fourth content is substantially similar to the third content;
identifying a quality control measure associated with the fourth content; and
generating a second notification comprising the quality control measure, wherein the quality control measure indicates success of applying the first recommendation to the process associated with the first process data.

10. The IMS of claim 1, wherein the first content represents an operating condition and relates to a departure of the manufacturing process from a nominal condition, wherein the operating condition deleteriously affects a property of a component produced by the manufacturing process.

11. The IMS of claim 10, wherein the second content identifies the deleteriously affected property.

12. A computer-implemented method, comprising:
receiving, by a device comprising at least one processor, first process control data relating to an operating condition of a manufacturing process;
comparing, by the device, the first process control data with a collection of process control data, wherein the collection of process control data comprises process data obtained from one or more manufacturing processes;
identifying, by the device, in the collection of operation data, second process control data, wherein the second process control data is substantially similar to the first process control data;
identifying, by the device, a quality control issue associated with the second process control data;
generating, by the device, a notification comprising the quality control issue; and
transmitting, by the device, the notification to facilitate presentment of the quality control issue.

13. The computer-implemented method of claim 12, wherein the quality control issue details a property of a component produced by the manufacturing process during a duration at which the second process control data was obtained.

14. The computer-implemented method of claim 12, wherein the device is located in a multi-tenant, cloud-based system.

15. The computer-implemented method of claim 14, wherein the manufacturing process from which the first process control data is a first manufacturing process and the second process control data is obtained from a second manufacturing process, wherein the first manufacturing process is communicatively coupled to the device via a first application interface and the second manufacturing process is communicatively coupled to the device via a second application interface, wherein the first application interface and the second application interface are disparate.

16. The computer-implemented method of claim 12, wherein the quality control issue represented by the second process control data indicates:
the manufacturing process, when the first process control data was captured, does not deleteriously affect a property of a component produced by the manufacturing process, or
the manufacturing process, when the first process control data was captured, has potential to deleteriously affect the property of a component produced by the manufacturing process.

17. A computer program product stored on a non-transitory computer-readable medium and comprising machine-executable instructions, wherein, in response to being executed, the machine-executable instructions cause an intelligent manufacturing system (IMS) to perform operations, comprising:
receiving first data from a first manufacturing process, wherein the first manufacturing process is manufacturing a first component;
comparing the first data with a collection of process data, wherein the collection of process data was obtained from a second manufacturing process manufacturing a second component, wherein the second component is substantially similar to the first component;
identifying second data in the collection of process data, wherein the second data is threshold similar to the first data, and the second data has an associated product quality measured during manufacture of the second component; and
in the event of the associated product quality of the second component is outside of an acceptable tolerance, transmitting a recommendation to the first manufacturing process regarding subsequent operation of the first manufacturing process.

18. The computer-program product of claim 17, wherein the IMS is located in a multi-tenant, cloud-based system, the first manufacturing process is communicatively coupled to the IMS via a first application interface and the second manufacturing process is communicatively coupled to the IMS via a second application interface.

19. The computer-program product of claim 17, wherein the recommendation is one of adjust operation of the first manufacturing process or terminate operation of the first manufacturing process.

20. The computer-program product of claim 17, wherein:
the first manufacturing process and second manufacturing process are co-located in a common facility, or
the first manufacturing process is located at a first location and the second manufacturing process is located at a second location, and the first location is remote to the second location.
